(19) United States
(12) Patent Application Publication
(10) Pub. No.: US 2026/0127857 A1
(43) Pub. Date: May 7, 2026

(54) SYNTHETIC LICENSE PLATE DATA GENERATION

(71) Applicant: Metropolis IP Holdings, LLC, Santa Monica, CA (US)

(72) Inventors: Ji Sung Hwang, Albany, CA (US); Anil Kumar Nayak, Los Angeles, CA (US); Long Ngo Hoang Truong, Garden Grove, CA (US)

(21) Appl. No.: 18/940,792

(22) Filed: Nov. 7, 2024

(51) Int. Cl. G06V 10/774; G06V 10/776; G06V 20/62; G06V 30/19

(52) U.S. Cl. CPC G06V 10/774; G06V 10/776; G06V 20/625; G06V 30/19093

(57) ABSTRACT

A method or system for enhancing vehicle identification accuracy. The system identifies a gap in a training dataset for training a license plate identification model. The gap represents underrepresented visual characteristics in misidentified license plates. A guidance prompt is generated based on the visual characteristics of the misidentified license plate. Condition embeddings are then generated from the guidance prompt, which are used to condition a diffusion model to create synthetic license plate images. The diffusion model is trained to receive a real license plate image, encode it into a vector, apply forward diffusion to add noise, and then apply reverse diffusion to remove the noise, resulting in a denoised vector that represents a synthetic license plate image conditioned by the condition embeddings. The denoised vector is then decoded to produce the synthetic license plate image. The synthetic images are then used to retrain the license plate identification model.

### TECHNICAL FIELD

The disclosure generally relates to the field of computer vision, and more particularly relates to using diffusion model to generate synthetic images.

### BACKGROUND

Computer vision is a field of artificial intelligence (AI) focused on enabling computers to interpret and make decisions based on visual data. Computer vision includes the use of algorithms and machine learning models to analyze images and videos, extract meaningful information, and perform tasks that typically require human visual understanding. Such machine learning models may include image recognition, image classification, object detection, image segmentation, pose estimation, scene understanding, among others. For example, a license recognition model may be trained to automatically detect and recognize license plates within images or video frames. Such a model may be implemented for access control in restricted areas, such as parking facilities, residential or commercial areas, toll roads, etc.

Notably, a sufficient amount of training data is generally required for training a computer vision model due to the complexity and diversity of visual information in real-world applications. Real-world images exhibit large variability, such as differences in lighting, angle, backgrounds, object appearances, sizes, and poses. A model trained on limited data may only perform well on a narrow range of conditions, failing to generalize to unseen scenarios. Further, with a small dataset, a model may “memorize” specific features of the training images instead of learning generalized patterns. This can lead to overfitting, where the model performs well on training data but poorly on new data.

Furthermore, real-world datasets may have insufficient or uneven coverage. For example, for a license recognition model, the real-world dataset may have gaps in data for certain license plate layouts, states, characters, lighting conditions, angles, or environmental factors. This can lead to poor model performance in recognizing certain types of plates or underrepresented variations.

### SUMMARY

Embodiments described herein address the above-describe limitations by training and applying a machine learning model (e.g., a diffusion model) to generate synthetic license plate images conditioned on layout conditions of a license plate. The generated synthetic license plate images can then be used to train or retrain a license plate identification model.

Embodiments described herein include a system or a method for enhancing vehicle identification accuracy. The system identifies a gap in a training dataset for training a license plate identification model. The gap represents underrepresented visual characteristics in misidentified license plates. A guidance prompt is generated based on the visual characteristics of the misidentified license plate. Condition embeddings are then generated from the guidance prompt, which are used to condition a diffusion model to create synthetic license plate images. The diffusion model is trained to receive a real license plate image, encode it into a vector, apply forward diffusion to add noise, and then apply reverse diffusion to remove the noise, resulting in a denoised vector that represents a synthetic license plate image conditioned by the condition embeddings. The denoised vector is then decoded to produce the synthetic license plate image. The synthetic images are then used to retrain the license plate identification model.

In some embodiments, the system receives a guidance prompt specifying elements of a license plate, including a jurisdiction of the license plate. The system uses a first language model to parse the guidance prompt to extract these elements, which are then applied to a pre-trained layout generation model to produce a license plate layout. The layout generation model is trained on real license plate images with labeled bounding boxes identifying each element. The system then uses a second language model to generate a set of condition embeddings based on the license plate layout. The system then applies a machine learning model (e.g., a diffusion model conditioned on the set of condition embeddings) to generate synthetic license plate images, and uses the synthetic license plate images to train or retrain a license plate identification model.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for managing vehicle parking or transit through a managed facility, using an edge device and a vehicle management server.

FIG. 2 illustrates one embodiment of exemplary modules operated by an edge device in accordance with one or more embodiments.

FIG. 3 illustrates one embodiment of exemplary modules operated by a vehicle management server in accordance with one or more embodiments.

FIG. 4 illustrates one embodiment of an exemplary process of training and retraining a machine-learning model for vehicle identification in accordance with one or more embodiments.

FIG. 5 illustrates example license plate images that represent different layout under different lighting in accordance with one or more embodiments.

FIG. 6 illustrates an example architecture of the synthetic image generation module in accordance with one or more embodiments.

FIG. 7 illustrates an example architecture of the layout generation module, in accordance with one or more embodiments.

FIG. 8 illustrates an example architecture of a dual-attention module, in accordance with one or more embodiments.

FIG. 9 illustrates an example architecture of a diffusion model, in accordance with one or more embodiments.

FIG. 10 illustrates an example architecture of a UNet, in one or more embodiments.

FIG. 11 depict one embodiment of an exemplary method for improving vehicle identification accuracy in a vehicle management system in accordance with one or more embodiments.

FIG. 12 depict one embodiment of an exemplary method for improving vehicle identification accuracy in a vehicle management system in accordance with one or more embodiments.

FIGS. 13A-13C depict embodiments of an exemplary managed facility vicinity and moveable gate.

FIG. 14 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Vehicle identification systems may be employed for traffic management, ensuring security at various checkpoints, and overseeing entry and exit activities in managed facilities. These systems may use a pretrained machine-learning model to identify vehicles as they pass by. For instance, within a managed facility, a vehicle identification system may be configured to recognize and record an identification of a vehicle upon entry and again at exit. This data may facilitate the determination of the vehicle's parking duration, which may subsequently be used to determine an applicable parking fee. This data may also be used to track traffic pattern for other purposes. However, such a machine-learning model may sometimes misidentify vehicles. As a result, certain recorded vehicle identifications at the entry or exit of a managed facility may lack a corresponding exit or entry event, leading to discrepancies in vehicle tracking. These unmatched entry or exit events are also referred to as “hanging entry events” or “hanging exit events”, collectively, referred to as “hanging events.”

The pretrained machine-learning model for vehicle identification may include a model specifically trained to identify license plates. Misidentification of vehicles may occur due to gaps in the dataset used to train the model, where certain license plate variations are underrepresented. For instance, this gap may arise if the previous model was trained using license plate data from one state, but the system is now deployed in another. Alternatively, the gap may be due to a new license plate design introduced by a state or a lack of real-world images that capture similar lighting conditions, angles, or environmental factors as those in the misidentified images.

Embodiments described herein address this problem by training and applying a diffusion model to generate synthetic license plate images that fill these gaps in the existing dataset, allowing the synthetic images to be used to retrain or fine-tune existing license plate identification models.

In some embodiments, a system includes a model training module configured to improve the performance of license plate identification model by addressing gaps in existing datasets. These gaps, which may cause misidentification, are first identified by a data gap identifier that analyzes data distribution patterns or flags recurring misidentifications of license plates by the existing models.

To fill the identified gaps, the system incorporates a synthetic image generation module that employs a diffusion model. This model uses a forward and reverse diffusion process to generate realistic license plate images, ensuring they closely match real-world data. The diffusion model operates by incrementally denoising noisy data, guided by conditioning inputs. These inputs include layout, text, and mask information, enabling the model to control specific aspects of the image, such as the positioning of license plate characters and their visual details. The result is a synthetic image that replicates specific visual attributes found in real-world license plates.

The diffusion model is trained and evaluated based on various metrics, such as SSIM (structural similarity index) and FID (Fréchet inception distance) to confirm that the generated images achieve sufficient similarity to real license plate images. Once these metrics confirm the diffusion model's accuracy, the model is approved for production, where it can begin generating images to supplement the existing dataset.

In some embodiments, to further enhance the quality of the data used for model retraining, the synthetic data exporter employs an optical character recognition (OCR) based system and a contrastive language-image pretraining (CLIP) based scoring mechanism to evaluate the relevance and accuracy of each generated image. Only high-quality synthetic images, as determined by their alignment with the intended structural features and textual descriptions, are selected for use. These selected images are then used to train, retrain or fine-tune vehicle identification models, providing a more comprehensive dataset that strengthens model accuracy and robustness. This synthetic data generation approach ensures that license plate identification models are better equipped to handle diverse conditions and new visual scenarios, enhancing their reliability and performance in real-world applications.

### Configuration Overview

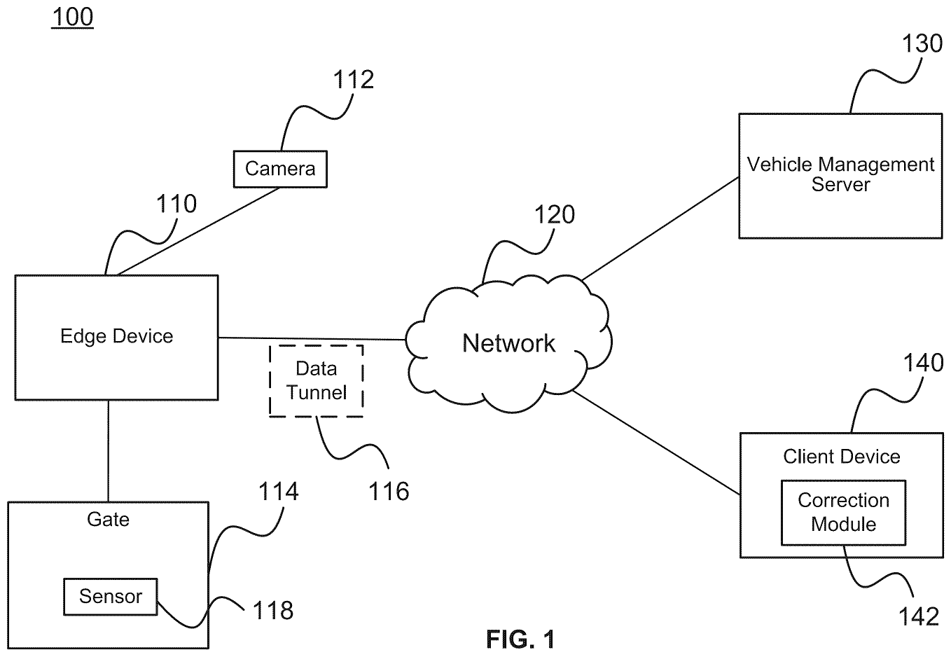

FIG. 1 illustrates one embodiment of a system environment for managing vehicle parking or transit through a managed facility, using an edge device and a vehicle management server. As depicted in FIG. 1, environment 100 includes edge device 110, camera 112, gate 114, data tunnel 116, sensor 118, network 120, a client device 140, and vehicle management server 130. While only one of each feature of environment is depicted, this is for convenience only, and any number of each feature may be present. Where a singular article is used to address these features (e.g., “camera 112”), scenarios where multiples of those features are referenced are within the scope of what is disclosed (e.g., a reference to “camera 112” may mean that multiple cameras are involved).

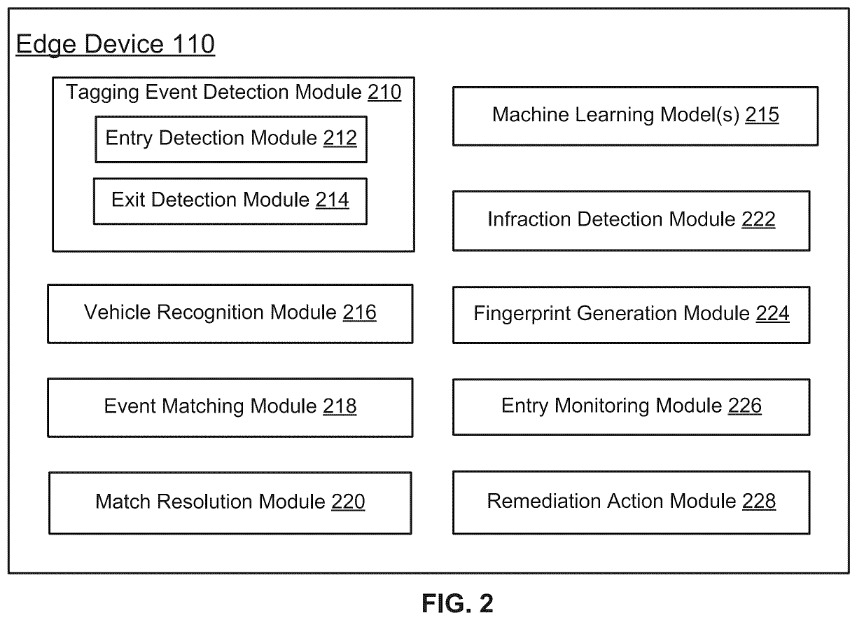

Edge device 110 detects a vehicle approaching gate 114 using camera 112. Edge device 110, upon detecting such a vehicle, performs various operations (e.g., lift the gate; update a profile associated with the vehicle, etc.) that are described in further detail below with reference to at least FIG. 2. Camera 112 may include any number of cameras that capture images and/or video of a vehicle from one or more angles (e.g., from behind a vehicle, from in front of a vehicle, from the sides of a vehicle, etc.). Camera 112 may be in a fixed position or may be movable (e.g., along a track or line) to capture images and/or video from different angles. Where the term image is used, this may be a standalone image or may be a frame of a video. Where the term video is used, this may include a plurality of images (e.g., frames of the video), and the plurality of images may form a sequence that together form the video.

Gate 114 may be any object that blocks entry and/or exit from a facility (e.g., a parking facility) until moved. For example, gate 114 may be a pike that blocks entry or exit by standing parallel to the ground, and lifts perpendicular to the ground to allow a vehicle to pass. As another example, gate 114 may be a pole or a plurality of poles that block vehicle access until lowered to a position that is flush with the ground. Any form of blocking vehicle ingress/egress that is moveable to remove the block is within the context of gate 114. In some embodiments, no physical gate exists that blocks traffic from entering or exiting a facility. Rather, in such embodiments, gate 114 as referred to herein is a logical boundary between the inside and the outside of the facility, and all embodiments disclosed herein that refer to moving the gate equally refer to scenarios where a gate is not moved, but other processing occurs when an entry and exit match (e.g., record that the vehicle has left the facility). Yet further, gate 114 may be any generic gate that is not in direct communication with edge device 110. Edge device 110 may instead be in direct communication with a component that is separate from, but installed in association with, a gate, the component configured by installation to cause the gate to move.

Edge device 110 communicates information associated with a detected vehicle to vehicle management server 130 over network 120, optionally using data tunnel 116. Data tunnel 116 may be any tunneling mechanism, such as virtual private network (VPN). Network 120 may be any mode of communication, including cell tower communication, Internet communication, WiFi, WLAN, and so on. The information provided may include images of the detected vehicle. Additionally or alternatively, the information provided may include information extracted from or otherwise obtained based on the images of the detected vehicle (e.g., as described further below with respect to FIG. 2). Transmitting extracted information rather than the underlying images may result in bandwidth throughput efficiencies that enable real time or near-real-time movement of gate 114 by avoiding a need to transmit high data volume images.

In some embodiments, edge device 110 may apply computer vision to determine environmental factors around the vehicle. The term environmental factors, as used herein, may refer to features that influence traffic flow in the vicinity of gate 114, such as street traffic blocking egress from a facility, orientation of vehicles within images with respect to one another, and so on. In an embodiment, when instructing the moveable gate to move, edge device 110 applies parameters based on the determined environmental factors (e.g., wait to open gate 114 despite matching an exit to an entry due to a vehicle being ahead of the vehicle attempting to exit and therefore blocking egress).

The machine vision may include a license plate detection model. The edge device 110 may apply the license plate detection model to identify license plate numbers on a vehicle when the vehicle enters or exits the managed facility. The identified license plate numbers at the entry event and the exit event may be logged in a database. The entry event and exit event associated with a same license plate number are matched and can be used to determine the vehicle's parking duration in the managed facility or anomalies.

At times, edge device 110 may incorrectly detect a license plate number during an entry or exit event, resulting in hanging entries and exits. While some of these mismatches can be resolved automatically by the edge device through additional data associated with the vehicles, such as color, size, and model of the vehicles, others remain unresolvable. Further, when the edge device 110 incorrectly match an entry event and an exit event, a user of the vehicle may receive an incorrect billing information.

To resolve persistent hanging events and correct incorrect billing incidents, a user may use a client device 140 that includes a correction module 142 to manually correct the discrepancies. In some embodiments, users can review images associated with unresolved events and adjust any incorrectly identified license plate numbers via the correction module 142. Successful corrections should allow for accurate matching of the updated entries with their corresponding corrected exits. The users may include managed facility operators or vehicle owners.

In some embodiments, the correction module 142 may be a management portal for operators of the managed facility to oversee all hanging events. Additionally, or alternatively, the correction module 142 may be a user portal or a mobile application installed on a driver's device. Through this application, drivers may review their billing information. When a driver receives incorrect billing information, the driver may be granted access to review images associated with their entry and exit of the managed facility. If those images are incorrectly associated with their vehicle or account, a user can either dispute the misidentified license plate directly through the correction module 142, or submit the correct license plate number corresponding to those images. In some embodiments, after a dispute is initiated, the user may also be granted access to images associated with hanging events, which allows the user to identify a correct image corresponding to their vehicle.

In some embodiments, the license plate images associated with the hanging events may serve as indicators of gaps in license plate identification training data. Each hanging event indicates a potential misidentification or failure to recognize certain visual characteristics on license plates, such as a specific state's license plate design, specific lighting conditions, angles, or environmental factors that were not sufficiently represented in the training dataset. The correction module 142 allows users to review and manually correct any misidentified license plate images associated with the event. By examining the corrected information across multiple hanging events, the system can identify common visual features in the misidentified images. These recurring characteristics indicate specific data deficiencies, or “gaps” in the existing training dataset, guiding the generation of new synthetic images that address these shortcomings and improve the model's robustness.

Vehicle management server 130 receives the information from edge device 110 and performs operations based on that receipt. The operations may include storing the information, updating a profile, retrieving information related to the information, and communicating responsive additional information back to edge device 110. Vehicle management server 130 may control aspects of the managed facility, such as status lights above parking gates.

Further, vehicle management server 130 also receives correction data from the client device 140, transforms the correction data into new training examples, and causes the license plate detection model to be retrained with the new training examples.

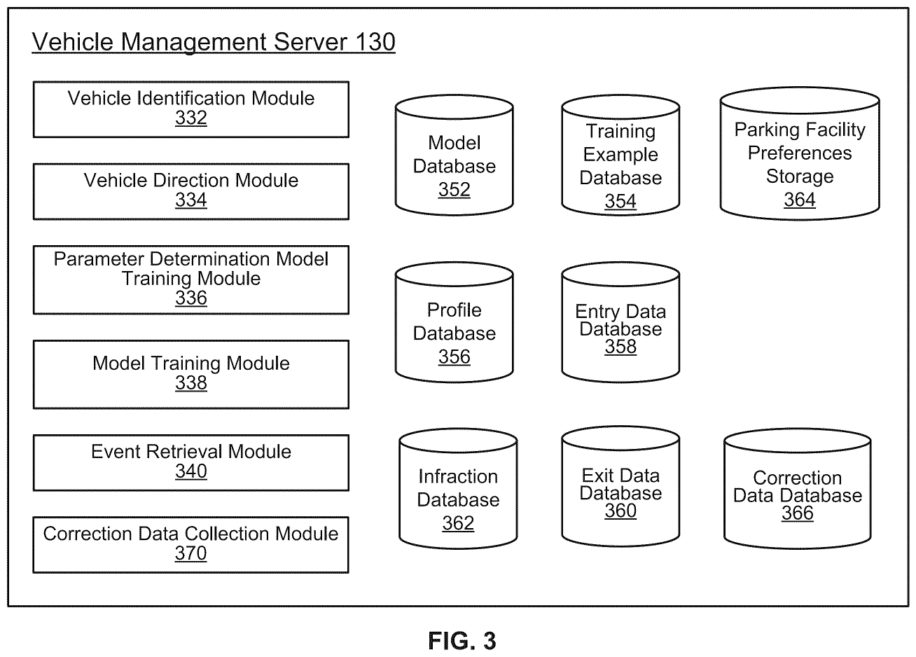

The operations of vehicle management server 130 are described in further detail below with reference to at least FIG. 3.

FIG. 2 illustrates one embodiment of exemplary modules operated by an edge device. As depicted in FIG. 2, edge device 110 includes a tagging event detection module 210, machine-learning model(s) 215, vehicle recognition module 216, event matching module 218, match resolution module 220, infraction detection module 222, fingerprint generation module 224, entry monitoring module 226, and remediation action module 228. The modules depicted with respect to edge device 110 are merely exemplary; fewer or additional modules may be used to achieve the activity disclosed herein. Moreover, the modules of edge device 110 typically reside in edge device 110, but in various embodiments may instead, in part or in whole, reside in vehicle management server 130 (e.g., where images, rather than data from images, are transmitted to vehicle management server 130 for processing). In some embodiments, the modules and functionality of edge device 110 may in whole or in part be implemented in sensor 118.

The tagging event detection module 210 is configured to detect and tag certain events. The events that are being tagged may include entry events, exit events, parking events, and backup events, among others. Entry events include an event when a vehicle enters the managed facility. Exit events include an event when a vehicle exits the managed facility. Some managed facilities include multiple zones, such as a commercial zone and a residential zone. In such a managed facility, an entry event may also be an event when a vehicle enters a zone of the managed facility; an exit event may also be an event when a vehicle exits a zone of the managed facility.

Events related to vehicles in a managed facility may occur in sequences that are logically related. Pairing these events helps facilitate effective management of managed facilities. For instance, an entry of a vehicle into a commercial zone (which may be a general mall parking) followed by its transition to a residential zone represents a pair of events that are logically related. Similarly, a vehicle entering a stadium and subsequently accessing a VIP parking area also represents a pair of events that are logically related.

Considering that entry and exit events are commonly detected, further details about these events are discussed below. Additionally, there are other events related to vehicles that can also be tagged and matched in a sequence between an entry event and an exit event. While the descriptions primarily relate to entry and exit events, the embodiments described herein are also applicable to these other events.

In some embodiments, the tagging event detection module 210 includes an entry detection module 212 configured to detect entry events and an exit detection module 214 configured to detect exit events. Entry detection module 212 detects and stores an entry event. An entry event represents a vehicle approaching a managed facility from an entry side and entering the managed facility or a zone of the managed facility, in some embodiments through an entry gate. Entry detection module 212 may detect the entry event by using camera 112 to capture a series of images over time. Camera 112 may continuously capture images or may capture images when certain conditions are met (e.g., motion is detected, or any other heuristic such as during certain times of day). In an embodiment, edge device 110 may continuously receive images from camera 112 and may determine whether the images include a vehicle, in which case entry detection module 212 may perform processing on images that include a vehicle and discard other images. In an embodiment, entry detection module 212 may command camera 112 to only transmit images that include vehicles and may perform processing on those images. The captured images are in association with a moveable gate or logical boundary (e.g., gate 114), in that each camera 112 is either facing a gate or an area in a vicinity of a gate (e.g., just the entry side, just the exit side, or both). Each image may have a timestamp and/or a sequence number. Entry detection module 212 may associate all images that include a motion of a given vehicle from a time the vehicle enters the images until the time that the vehicle exits the images (e.g., during the time that the vehicle approaches the gate and then drives through or past the gate). In some embodiments, entry detection module 212 may, for images that include motion of the given vehicle, isolate portions of the images that contain the vehicle and exclude portions of the images that do not contain the vehicle (e.g., background, environment, other vehicles). For example, entry detection module 212 may put a bounding polygon on a portion of an image that contains the largest vehicle in the frame. From images that contain the vehicle, entry detection module 212 may further isolate or put bounding polygons around a portion of the image that contains a vehicle identifier, such as a license plate.

Entry detection module 212 may determine, from images featuring the vehicle, a data set corresponding to the vehicle. The data set may include parameters that describe attributes of the vehicle and a vehicle identifier. Parameters describing attributes of the vehicle may include both identifying attributes and direction attributes of the vehicle. Identifying attributes may include any information that is derivable from the images that describe the vehicle, such as make, model, color, type (e.g., sedan versus sports utility vehicle), height, length, bumper style, number of windows, door handle type, and any other descriptive features of the vehicle. Direction attributes may refer to absolute direction (e.g., cardinal direction) or relative direction (e.g., direction of the vehicle relative to an entry gate and/or relative to an assigned direction of a lane which the entry gate blocks (e.g., where different gates are used for entry and exit lanes, and where a vehicle is approaching a gate from an entrance to a managed facility through an exit lane, the direction would be indicated as opposite to an intended direction of the lane)). Direction attributes may also be determined relative to a camera's imaging access and are thus indicative of whether the vehicle is moving toward or away from the camera.

The machine-learning model(s) 215 are used to process the images associated with the entry event and exit event. In some embodiments, the entry detection module 212 and the exit detection model 214 apply the machine-learning model(s) 215 to the captured images to determine identifications of the vehicles.

In an embodiment, a single machine-learning model is used to produce the entire data set, both the parameters and the vehicle identifier. In another embodiment, a first machine-learning model is used to determine the parameters and a different second machine-learning model is used to determine the vehicle identifier.

In the two-model approach, entry detection module 212 determines the parameters by inputting images featuring the vehicle into a first machine-learning model, and receiving, as output from the first machine-learning model, the parameters describing attributes of the vehicle. In an embodiment, the output of the first machine-learning model may be more granular, and may include a number of objects in an image (e.g., how many vehicles), types of objects in the image (e.g., vehicle type information, or per-vehicle identifying attribute information), result scores (e.g., confidence in each object classification), and bounding boxes (e.g., of sub-segments of the image for downstream processing, such as of a license plate for use by the second machine-learning model).

The first machine-learning model may be trained to output identifying attributes using example data having images of vehicles that are labeled with one or more candidate identifying attributes. For example, various images from cameras facing gates may be manually labeled by users to indicate the above-mentioned attributes, such as, for each of the various images, a make, model, color, type, and so on of a vehicle. The first machine-learning model may be a supervised model that is trained using the example data to predict, for new images, their attributes.

The first machine-learning model may be trained to output direction attributes of the vehicle using example data, and/or to output data from which entry detection module 212 may determine some or all of the direction attributes. The example data may show motion of vehicles relative to one or more gates over a series of sequential frames, and may be annotated with a lane type (e.g., an entry lane versus an exit lane) and/or a gate type (e.g., exit gate versus entry gate), and may be labeled with a direction between two or more frames (e.g., toward an entry gate, away from an entry gate, toward an exit gate, away from an exit gate). Lane type may be derived by environmental factors (e.g., a model may be trained to recognize through enough example data that a direction past a gate that shows blue sky is an exit direction, and toward a halogen light is an entry direction). From this training, the first machine-learning model may output direction directly based on learned motions relative to gate type and/or lane type, or may output lane type and/or gate type as well as indicia of directional movement, from which entry detection module 212 may apply heuristics to determine the direction attributes (e.g., toward entry gate, away from entry gate, toward exit gate, away from exit gate). That is, a direction vector along with a gate type and/or lane type may be output (e.g., environmental factors may be output along with the direction vector, which may include other information such as lighting, sky information, and so on), and the direction vector along with the environmental factors may be used to determine the direction attribute.

It is advantageous to determine direction attributes along with identifying attributes, as vehicles are being tracked as they move. However, determining direction attributes and identifying attributes in one step may result in false positives. With that being said, a separate model could be used for identifying attribute detection and for direction attribute detection, thus resulting in a three-model approach (two models being used for what above is referenced to as a “first machine-learning model”, each of those separate models trained separately using respective training data for each respective task.

Continuing with the two-model approach, entry detection module 212 determines the vehicle identifier by inputting images featuring a depiction of a license plate of the vehicle into a second machine-learning model. That is, rather than using optical character recognition (OCR), the second machine-learning model may be used to decipher a license plate of the vehicle into a vehicle identifier of the vehicle. OCR methods are often inaccurate for license plate detection due to complexity of license plates, where different fonts (e.g., cursive versus script) are used, often against complex picture-filled backgrounds, different colors, and lighting issues. Moreover, various license plate types are difficult to accurately read because they often include slogans that are not generalizable. Even minor accuracies in OCR readings where one character or a geographical identifier determination is off could cause could result in an inability to effectively identify a vehicle.

To this end, the second machine-learning model may be trained to identify and output both a geographical nomenclature and a string of characters of a vehicle identifier (e.g., either directly, or with a confidence score that exceeds a threshold applied by entry detection module 212). As used herein, the term “geographical nomenclature” may refer to a manner of identifying a jurisdiction that issued the license plate. That is, in the United States of America, an individual state would issue a license plate, and the geographical identifier would identify that state. In some jurisdictions, a country-wide license plate is issued, in which case the geographical identifier is an identifier of the country. A geographical identifier may identify more than one jurisdiction (e.g., in the European Union (EU), some license plates identify both the EU and the member nation that issued the license plate; the geographical identifier may identify both of those places or just the member nation). The term “string of characters” may refer to a unique symbol issued by the jurisdiction to uniquely identify the vehicle, such as a “license plate number” (which may include numbers, letters, and symbols). That is, for each given jurisdiction, the string of characters is unique relative to other strings of characters issued by that given jurisdiction. In some embodiments, a license plate number for a vehicle may include a string of characters where the characters are both vertically written (e.g., read from top to bottom) and horizontally written (e.g., read from left to right). The term “license plate identifier” may refer to the combination of the geographical nomenclature and the license plate number.

To train the second machine-learning model, training examples of images of license plates are used, where the training examples are labeled. In an embodiment, the training examples are labeled with both the geographical jurisdiction and with characters that are depicted within the image. The characters may be individually labeled (e.g., by labeling segments of the image that include the segment), the whole image may be labeled with each character that is present, or a combination thereof. For strings of characters including both vertically and horizontally written characters, the string may be labelled in a standardized format, such as with a left to right, top to bottom rule (e.g., a license plate _{B}^{A}12345 may be labelled as AB12345, and a license plate

$${6}_{D}^{C}$$

7890 may be written as 6CD7890). In some embodiments, training examples may only be labeled by whether they include both vertically and horizontally written characters, and the second machine-learning model predicts for a new image of a license plate whether the license plate number includes both vertically and horizontally written characters. Following this prediction, entry detection module 212 may apply a third machine-learning model to license plates with vertically and horizontally written characters, the third machine-learning model trained specifically to predict the license plate numbers for license plates with both vertically and horizontally written characters.

In an embodiment, the training examples may be labeled only with the geographical jurisdiction, and the second machine-learning model predicts for a new image of a license plate the geographical jurisdiction. Following this prediction, a third machine-learning model from a plurality of candidate machine-learning models may be selected, each of the candidate machine-learning models corresponding to a different geographical jurisdiction and trained to predict characters of the string of characters from training examples specific to its respective geographical jurisdiction, the selected third machine-learning model selected based on the predicted geographical jurisdiction. The third machine-learning model may be applied to the image or segments thereof that contain each character, thus resulting in a prediction from training examples specific to that jurisdiction.

In any case, the training examples may show examples in any number of conditions, from low lighting conditions, dirty license plate conditions where characters are partially or fully occluded, license plate frame conditions where geographical identifiers (e.g., the word “New York”) are partially or fully occluded, license plate covers render characters hard to directly read, and so on. Advantageously, by using machine learning to predict geographical nomenclature and strings of characters, accuracy is improved relative to OCR, as even where partial occlusion occurs or lighting conditions make characters difficult to read, the second machine-learning model is able to accurately predict the content of the license plate.

In a one-model approach, the manners of training the first and second machine-learning model would be applied to a single model, rather than differentiating what is learned between the two models. This would result in an advantage of providing all inputs as one data set to a model, but could also result in a disadvantage of a less specialized model that has noisier output. Moreover, data and time intensive to train one large model to perform all of this functionality. The large model may be slower and have a lower quality of output than using two separate models. The two-model approach additionally allows for a “fail fast” processing to happen—that is, detect a vehicle and perform processing based on that detection, even before other activity (e.g., license plate reading) is completed.

Regardless of what model approach is used, in an embodiment, entry detection module 212 may determine, from direction attributes of the vehicle, whether the direction attributes of the vehicle are consistent with the function of the entry gate, thus confirming that the vehicle performed an entry event. Namely, the entry detection module 212 determines that the vehicle used or is using the entry lane as opposed to the exit lane. In some embodiments, the entry detection module 212 may move the gate to enable entry to the facility that is blocked by the gate (or where the gate is a logical boundary, record that the vehicle has entered the facility without a need to move the gate).

In some embodiments, entry detection module 212 may determine a feature vector corresponding to the entry event, an “entry feature vector.” To produce the entry feature vector, the entry detection module 212 inputs a depiction of the vehicle into a supervised machine-learning model. The depiction of the vehicle may include the images that include the vehicle, for example as captured by camera 112. In some embodiments, the depiction of the vehicle may include only the isolated portions of the images that contain the vehicle. In some embodiments, the depiction of the vehicle may include other data, such as data from the data set. The supervised machine-learning model outputs the entry feature vector. The entry feature vector may include a plurality of embeddings, where each embedding is derived from one or more dimensions of the depiction of the vehicle. The supervised machine-learning model may be trained to output a feature vector. In some embodiments, the supervised machine-learning model may be trained such that feature vectors corresponding to different vehicles have a maximum amount of distance from each other in the feature space. For example, the supervised machine-learning model may be trained such that a feature vector is penalized based on angular margins between the feature vector and other feature vectors, where the smaller the angular margins, the greater the penalties. This training results in a greater distance between feature vectors.

In some embodiments, the supervised machine-learning model may be a multi-task model, such as a multi-task neural network with branches that are each trained to determine different parameters. The structure of the multi-task model has a set of shared layers and a plurality of branching task-specific layers, each branch of the branching task-specific layers corresponding to a task. The tasks are related within the domain, meaning that each of the tasks determines parameters that are determinable based on a highly overlapping information space. For example, in determining the entry feature vector for the vehicle, the different tasks may predict the license plate of the vehicle, the make and model of the vehicle, and so on. As such, when trained, the shared layers produce information that is useful for performing each of tasks and outputting each of these predictions. Embeddings of the one or more of the shared layers may be used to produce a feature vector.

While the model that entry detection module 212 uses to produce the entry feature vector is described as a supervised machine-learning model, a supervised machine-learning model is merely exemplary. Entry detection module 212 may use other types of models to generate entry feature vectors. For example, entry detection module 212 may use a classification model (e.g., a logistic regression, decision tree, random forest, or naive bayes model) to classify the vehicle in the entry event.

As described later with respect to event matching module 218 and match resolution module 220, the process to match an entry event and an exit event (e.g., a representation of a vehicle exiting the managed facility) may not always require the entry detection module 212 to generate a feature vector. Event matching module 218 may match entry and exit events without using feature vectors. For example, if the vehicle is a known vehicle, event matching module 218 may match an entry event to an exit event based on the vehicle's vehicle identifier alone. Or, in another example, event matching module 218 may match entry events to exit events based on the data set of the entry and exit events, for example matching based on type, model, and color of vehicle. However, responsive to event matching module 218 not finding a match between an entry and exit event, match resolution module 220 may attempt to match entry and exit events using feature vectors. Match resolution module 220 may request feature vectors from entry detection module 212. As such, in some embodiments, to avoid generating feature vectors when they may not necessarily be used in the matching process, entry detection module 212 may hold off on generating a feature vector responsive to detecting entry of a vehicle and instead produce an entry feature vector responsive to receiving a request from match resolution module 220. This approach saves on computer resources (e.g., processing power, memory) by first attempting less computationally expensive means to match entry and exit events before producing feature vectors.

Entry detection module 212 may store the entry event corresponding to the vehicle in entry data database 358 of the vehicle management server 130. The entry event corresponding to the vehicle includes the data set corresponding to the vehicle (e.g., the parameters and the vehicle identifier) and, in some embodiments, the entry feature vector, images featuring the vehicle, timestamps corresponding to the entry (e.g., time stamps and/or sequence numbers of the images), and the managed facility the vehicle entered. In an embodiment, the entry detection module 212 may store the entry event at edge device 110.

Exit detection module 214 operates in a manner similar to entry detection module 212, in that machine learning is applied in in a similar manner in order to detect an exit event. That is, a data set and/or feature vector identical to that determined when a vehicle performs an entry motion is performed for an exit motion, where it is detected that a vehicle is approaching gate 114 to exit a facility or a zone of the facility. When an exit motion is detected (e.g., where a vehicle is determined to have directional attributes consistent with approaching a gate designated for use as an exit), exit detection module 214 determines that an exit event may have occurred (e.g., and other activity such as generation and storage (e.g., in exit data database 360) of a data structure or a feature vector as described with respect to entry events may be performed). In some embodiments, exit detection module 214 may determine the feature vector in response to the edge device 110 determining that an exit event does not match an entry event.

Vehicle recognition module 216 determines if a vehicle is a known vehicle. A known vehicle is a vehicle with a profile stored in profile database 356. Vehicle recognition module 216 may retrieve the vehicle identifier (e.g., license plate) from the entry event associated with the vehicle (e.g., stored in entry data database 358). Vehicle recognition module 216 may search the profile database 356 using the vehicle identifier as an index. Responsive to finding an entry in profile database 356 that corresponds to the vehicle identifier, vehicle recognition module 216 determines that the vehicle is known. Vehicle recognition module 216 may determine if a vehicle is a known vehicle responsive to a vehicle entering or exiting the managed facility and as such may update the respective entry data database 358 or exit data database 360 with the vehicle identifier or with an indication that the vehicle is known and has a profile in profile database 356.

Event matching module 218, responsive to exit detection module 214 detecting an exit event, determines whether a match exists between the detected exit event and an entry event. Namely, event matching module 218 determines if a vehicle corresponding to an entry event is the same as the vehicle corresponding to the exit event. In some embodiments, the event matching process may be as simple as determining whether the vehicle corresponding to the exit event is known and matching the exit event to an entry event corresponding to the known vehicle. Event matching module 218 determines whether the vehicle corresponding to the exit event is known by using vehicle recognition module 216, which relies on the vehicle identifier (e.g., license plate) to search profile database 356 for a profile of the vehicle. Responsive to determining that the vehicle corresponding to the exit event is a known vehicle, event matching module 218 may search either entry data database 358 or profile database 356 with the vehicle identifier to determine if there exists a record of the known vehicle entering the managed facility. Responsive to finding an entry event for the known vehicle, event matching module 218 matches the exit event with the entry event.

However, license plate reading, even using the described second machine-learning model, is not perfect. Factors such as low image quality, low frame rate, lighting conditions (e.g., glare, low lighting), debris, dirt, or weather-related conditions (e.g., snow, ice, rain, mud) may obscure license plate information and make license plates difficult to read. As such, vehicle recognition module 216 may be unable to determine whether the vehicle is known based on the vehicle identifier, and as a result the event matching module 218 may not be able to match the exit event to the entry event using the vehicle identifier alone.

In some embodiments, event matching module 218 matches the exit event to an entry event by comparing information in the data set of the exit event to information in the data set of an entry event of a set of entry events. Event matching module 218 determines a match between the exit event and an entry event of the set of entry events where heuristics are satisfied. For example, event matching module 218 may determine that the exit event matches an entry event if the license plate number and geographical nomenclature match. Because license plate numbers are not unique identifiers and can be duplicated so long as the geographical nomenclature is unique, if the exit event and an entry event match between license plate numbers but not between geographical nomenclatures, event matching module 218 would not match the exit event with the entry event. As previously described, because license plate reading is not perfect, it may be the case that a match is not found by event matching module 218 using the vehicle identifier alone. To this end, a match may be determined based on other identifying information from the data sets of the exit and entry events, such as identifying a partial match of a geographical nomenclature and/or other vehicle attributes that match such as make, model, color, and so on. Any heuristics may be programmed to determine whether or not a match has occurred.

Event matching module 218 may filter the entry events to compare the exit event to. For example, event matching module 218 may compare the exit event only to unmatched entry events, to entry events associated with the same managed facility, or to entry events with timestamps within a threshold time window (e.g., within a 24-hour time window). Event matching module 218 may filter entry events such that the set of entry events includes events associated with vehicles of the same type (e.g., car or truck), color, or model as the vehicle associated with the entry event.

Responsive to detecting a match, event matching module 218 may instruct vehicle management server 130 to indicate in profile database 356, entry data database 358, or the exit data database 360 that the vehicle has exited the facility. For example, event matching module 218 may instruct vehicle management server 130 to delete the entry event and exit event of the vehicle or to archive them in a separate database. In some embodiments, responsive to detecting a match, event matching module 218 may raise gate 114 (e.g., where gate 114 is a physical gate rather than a logical boundary), thus allowing the vehicle to exit the facility.

Responsive to not detecting a match, event matching module 218 may expand the set of entry events that the exit event could be matched to and retry the matching process. For example, event matching module 218 may expand the set of entry events to include entry events associated with managed facilities beyond the managed facility associated with the exit event, such as managed facilities within a threshold distance from the managed facility associated with the exit event. In another example, event matching module 218 may expand the time window the entry events are associated with, for example to include entry events that took place within a month instead of within a day.

In some embodiments, responsive to not detecting a match between the exit event and an entry event, event matching module 218 may refer to match resolution module 220.

Match resolution module 220 resolves matches between exit events and hanging entry events. A hanging entry event is an entry event for a vehicle where entry detection module 212 was unable to identify a vehicle identifier. Match resolution module 220 may determine (e.g., by exit detection module 214) or retrieve (e.g., from exit data database 360) an exit feature vector corresponding to the exit event. Match resolution module 220 may determine (e.g., by entry detection module 212) or retrieve (e.g., from entry data database 358) a set of entry feature vectors corresponding to a set of hanging entry events. Match resolution module 220 may input the exit feature vector and the set of entry feature vectors into an unsupervised machine-learning model.

The unsupervised machine-learning model may output a matching score for each entry feature vector. The matching score may represent how well the entry event matches with the exit event such that better matches have higher matching scores. In these embodiments, match resolution module 220 may match the exit event with an entry event based on the matching scores. For example, match resolution module 220 may automatically match the exit event with the entry event that has the highest matching score. In other embodiments, match resolution module 220 may compare the match scores to a threshold score. Responsive to the highest match score exceeding the threshold score, match resolution module 220 may determine the entry event with the highest match score to be a match with the exit event. Responsive to the match scores not exceeding the threshold score, match resolution module 220 may determine that there is no match for the exit event. In some embodiments, match resolution module 220 may compare the difference between the two highest two match scores to a threshold difference and, only in response to the difference exceeding the threshold difference, match the exit event with the entry event with the highest match score. Thus, if the top two entry events are similarly well-matched to the exit event (e.g., with match scores within the threshold difference from one another), match resolution module 220 may determine that there is no match for the exit event. In other embodiments, the match resolution module 220 may provide, for display, a subset of entry events for an administrator to manually select a match for the exit event.

In some embodiments, match resolution module 220 may resolve hanging entry events without waiting for a matching exit event. To do so, match resolution module 220 may match a hanging entry event to a previous entry event, where the previous entry event corresponds to a known vehicle. Match resolution module 220 may determine or retrieve an entry feature vector corresponding to the hanging entry event and determine or retrieve (e.g., from entry data database 358) a set of entry feature vectors corresponding to previous entry events. Match resolution module 220 may input the entry feature vector corresponding to the hanging entry event and the set of entry feature vectors corresponding to previous entry events into an unsupervised machine-learning model. The unsupervised machine-learning model may output a matching score for each entry feature vector that corresponds to a previous entry event.

While the model that match resolution module 220 uses to resolve matches between exit events and hanging entry events is described as an unsupervised machine-learning model, an unsupervised machine-learning model is merely exemplary. Match resolution module 220 may use other types of models to generate entry feature vectors. For example, match resolution module 220 may use a mathematical model that uses cosine similarity to compute the similarity between exit and entry feature vectors.

Match resolution module 220 may select the set of previous entry events. Match resolution module 220 may select entry events that the entry detection module 212 detected within a window of time, such as a window of the last three days. Match resolution module 220 may select entry events that occurred at the same managed facility as the hanging entry event. Match resolution module 220 may select entry events with vehicles of the same type (e.g., truck, SUV, sedan), model, or color as the vehicle corresponding to the hanging entry event. In some embodiments, match resolution module 220 may start by selecting a smaller set of previous entry events where a match may be more likely (e.g., entry events that occurred at the same managed facility in the last 3 days), and, responsive to not resolving a match between the hanging entry event and the selected set of previous entry events, iteratively select larger and larger sets of previous entries with which to retry the matching process (e.g., entry events that occurred within the last month at managed facilities within 20 miles of the managed facility associated with the hanging entry event). Match resolution module 220 may use metrics like retention to further inform selection of the set of previous entry events. For example, if retention (e.g., the rate of vehicles returning to the same managed facility) is 80% in one month, match resolution module 220 may select the set of previous entry events to be entry events that occurred at the same managed facility within one month. However, if retention is 30% in one month, match resolution module 220 may select the set of previous events to be entry events that occurred at a group of managed facilities (e.g., within the same zip code, within a threshold distance) instead of the same managed facility within one month. By using an iterative search process to check sets of previous events where a match is more likely before expanding to check larger sets of previous events, match resolution module 220 may save on time as well as computational resources (e.g., processing power, storage, etc.).

Responsive to the event matching module 218 or match resolution module 220 matching the exit event with an entry event, in some embodiments, edge device 110 may update profile database 356 of the vehicle management server with any or all events, data sets or feature vectors that describe the vehicle. If the vehicle does not have a profile in profile database 356, edge device 110 may request for vehicle management server 130 to create a profile for the vehicle. If the vehicle does have an existing profile in profile database 356, edge device 110 may request for vehicle management server 130 to update the profile with new information corresponding to the vehicle (events, data sets, feature vectors). In some embodiments, edge device 110 may update the entry data database 358 and the exit data database 360 to reflect the match between an exit event and an entry event (e.g., removing entries or indicating that the event is matched).

Responsive to the event matching module 218 or match resolution module 220 not detecting a match, edge device 110 or vehicle management server 130 may provide a message for display to the user of the vehicle corresponding to the exit event. The message may include an indication that the user's vehicle was unable to be matched and/or a request for the user to manually enter vehicle information (e.g., license plate information) or create a profile. The managed facility may display the message on a screen, for example a screen located at the exit gate.

Notably, when the match resolution module 220 matches a hanging entry event and a hanging exit event, a license plate identification associated with at least one of these events is corrected. The corrected data can be gathered to create new training examples, which can then be used to retrain the machine-learning models for vehicle identification. In some embodiments, each recognized license plate is assigned to a confidence score that indicates a probability of its accurate identification. The matched hanging entry event and hanging exit event are each associated with a confidence score. In some embodiments, the license plate identification from the event with the higher confidence score is used for both events in the pair. As such, the event with the lower confidence score is subsequently updated to share the same license plate identification as its matched counterpart, which can then be used to generate a new training example.

Infraction detection module 222 detects infractions caused by vehicles and triggers remediation actions responsive to detecting entry of those vehicles. An infraction may be a violation of rules associated with the managed facility. A set of non-exhaustive examples of infractions may include damaging gates of the managed facility (e.g., bumping into or crashing through entry or exit gates), damaging other vehicles in the managed facility, entering the managed facility with no profile associated with the vehicle, speeding within the managed facility, taking up more than one parking space, parking outside of a parking space, or staying within the managed facility during restricted hours (e.g., overnight, past closing time, for too long a time period). In some embodiments, infraction detection module 222 may detect infractions caused by users of the managed facility, both users associated with vehicles and users not associated with vehicles. Infractions caused by users may, for example, include damaging, breaking into, or stealing vehicles.

Infraction detection module 222 may detect an infraction based on sensor data. Sensor data may include data from camera 112, sensor 118 attached to gate 114, a parking sensor, an audio sensor, a speedometer, or from any other type of sensor in the managed facility. A parking sensor detects when a vehicle is in a parking space. Example parking sensors include magnetometers, ultrasonic sensors, or optical sensors. Infraction detection module 222 may use different sensors for different types of infractions. For example, infraction detection module 222 may use sensor 118 to detect if a gate has moved from one of the operating states (e.g., open, closed) to a state of being ajar, which may indicate that a vehicle bumped into the gate. In another example, infraction detection module 222 may use an audio sensor to detect when a vehicle is broken into (e.g., by detecting the sound of glass shattering or a car alarm).

In some embodiments, infraction detection module 222 may use multiple sensors in combination to detect the infraction. For example, infraction detection module 222 may use camera 112 and a combination of parking sensors to determine if a vehicle is in more than one parking space. Responsive to two or more parking sensors for two or more adjacent parking spaces detecting that the parking spaces have transitioned from a vacant state (e.g., no vehicle detected) to an occupied state (e.g., vehicle detected) within a threshold amount of time, infraction detection module 222 may detect an infraction. Infraction detection module 222 may use camera 112 data to confirm whether the instance of two parking sensors for adjacent parking spots detecting vehicles at the same time included the parking sensors detecting two or more separate vehicles that happened to pull in at the same time or detecting one vehicle taking up multiple parking spaces. In another example, infraction detection module 222 may use an audio sensor to detect the sounds of shattering glass and a car alarm and use camera 112 to confirm an infraction involving a user breaking into a vehicle.

In some embodiments, infraction detection module may use a moveable camera system. A set of non-exhaustive examples of moveable camera systems include a camera on wheels (e.g., on a vehicle), a camera configured to move along a wire or beam running across a ceiling, and/or a drone camera. Infraction detection module 222 may command the moveable camera system to navigate to the location of the infraction. For example, infraction detection module 222 may command the moveable camera system to navigate to a vantage point comprising the aforementioned adjacent parking spaces, capture images of the adjacent parking spaces, and determine whether the vehicle is occupying the adjacent parking spaces. In some embodiments, infraction detection module 222 may command the moveable camera system to navigate to the location of the infraction responsive to sensor data from another sensor (e.g., parking sensor) detecting the infraction. In some embodiments, infraction detection module 222 may command the moveable camera system to periodically move through the managed facility, scanning for infractions. For detecting infractions, a moveable camera system may be more efficient than a system with many stationary cameras as it reduces resources required to install cameras throughout a managed facility and maintain the cameras (e.g., power the cameras while the managed facility is open). Moreover, by triggering navigation of the moveable camera system responsive to detection of certain sensor data, fuel, energy, and processing of images from the moveable camera system is minimized to only scenarios where the possibility of an infraction is first detected, thereby improving efficiency.

In some embodiments, infraction detection module 222 may log the infraction in infraction database 362 along with other information associated with the infraction (e.g., timestamp).

Fingerprint generation module 224 generates a vehicle fingerprint in response to the detection of an infraction. A vehicle fingerprint for an infracting vehicle may include a feature vector corresponding to the vehicle, an “infraction feature vector.” The fingerprint may include other information associated with the vehicle, for example a vehicle identifier or various vehicle parameters. Fingerprint generation module 224 generates the vehicle fingerprint by inputting a depiction of the vehicle into a model (e.g., a supervised machine-learning model). The depiction of the vehicle may include the images that include the vehicle, for example as captured by camera 112. The model may be similar to the supervised machine-learning model or other models described with respect to entry detection module 212 and thus may be trained as discussed with respect to entry detection module 212. Fingerprint generation module 224 receives, as output from the model, an infraction feature vector describing the vehicle involved in the detected infraction. The infraction feature vector may include a plurality of embeddings, where each embedding is derived from one or more dimensions of the depiction of the vehicle. In some embodiments, fingerprint generation module 224 adds the infraction feature vector to an infraction database, such as infraction database 362. In some embodiments, fingerprint generation module 224 generates a vehicle fingerprint without the detection of an infraction.

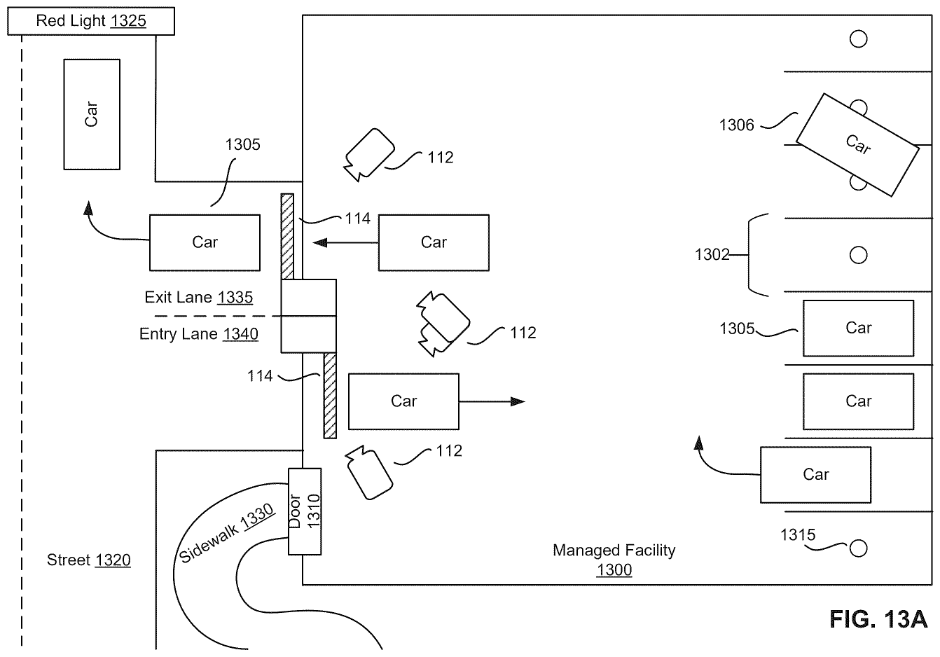

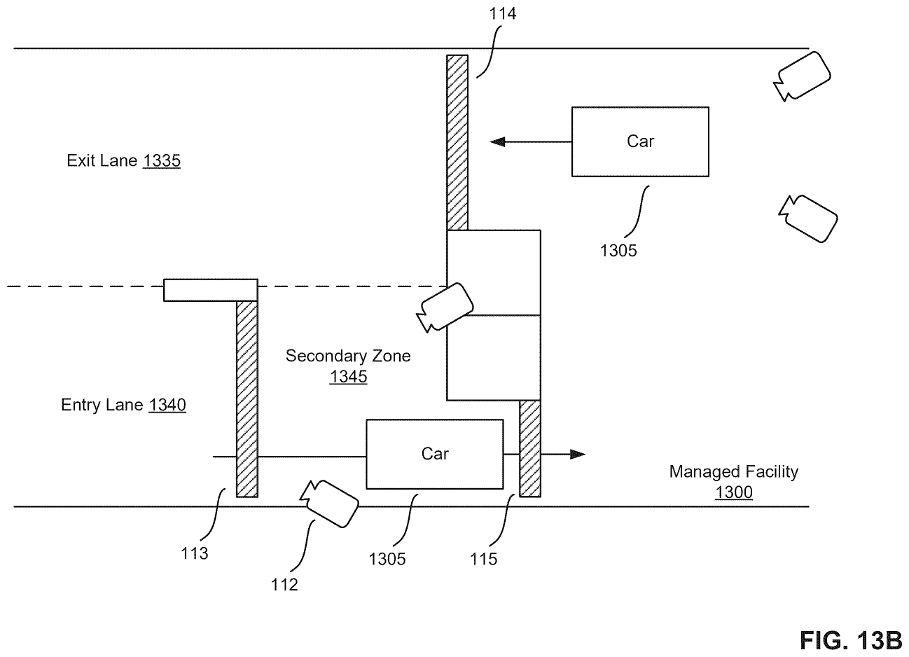

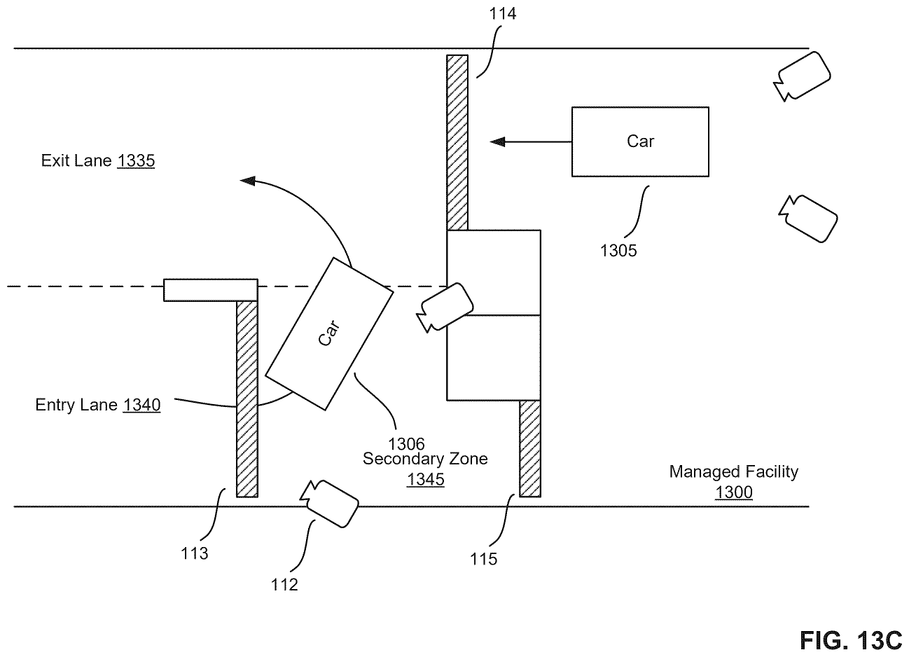

In embodiments where infraction detection module 222 detects an infraction caused by a user, fingerprint generation module 224 may determine a vehicle associated with the user and generate a vehicle fingerprint for the user's vehicle. To do so, fingerprint generation module 224 may retrieve a timestamp of the infraction from infraction database 362. Fingerprint generation module 224 may access sensor data (e.g., RFID reader on a locked pedestrian door to the managed facility, camera 112) within a threshold time window around the timestamp of the infraction. Using the sensors, fingerprint generation module 224 may determine how the user entered the managed facility. Responsive to determining that the user entered through an RFID-enabled pedestrian door to the managed facility, fingerprint generation module 224 may access logs associated with the pedestrian door and access a set of user credentials through which the user gained entry into the managed facility. User credentials may include user information, such as user profile information, through which fingerprint generation module 224 may obtain the vehicle identifier associated with the user. Responsive to determining that the user entered the managed facility in a vehicle, fingerprint generation module 224 may obtain the vehicle information stored in the entry log associated with the vehicle. Such embodiments are further described with respect to FIG. 13A.

In some embodiments, fingerprint generation module 224 determines whether the vehicle is unknown and generates a vehicle fingerprint in response to the vehicle being unknown. The vehicle may be determined by fingerprint generation module 224 to be unknown responsive to determining that the vehicle does not exist in profile database 356 or if the vehicle identifier (e.g., geographical nomenclature and license plate number) for the vehicle is not recognized. To determine if the vehicle is unknown, fingerprint generation module 224 may extract the vehicle identifier from the vehicle using a model similar to the supervised machine-learning model described with respect to entry detection module 212. Fingerprint generation module 224 may search the profile database 356 using the vehicle identifier as an index. Responsive to determining that the vehicle is known, fingerprint generation module 224 may use an existing feature vector of the vehicle (e.g., an entry or exit feature vector stored in profile database 356) as the infraction feature vector of the vehicle fingerprint.

Entry monitoring module 226 monitors for the entry of vehicles associated with infractions to any of a plurality of managed facilities. At each managed facility, entry monitoring module 226 may receive, from entry detection module 212, a data set and/or entry feature vector corresponding to a vehicle entering the managed facility. Entry monitoring module 226 may compare the entry feature vector of the vehicle to vehicle fingerprints stored in the infraction database. In some embodiments, entry monitoring module 226 may input the entry feature vector and a set of infraction feature vectors (e.g., from vehicle fingerprints) into a model and receive, as output from the model, a match score for each infraction feature vector. The model may be similar to the unsupervised machine-learning model of match resolution module 220. The entry monitoring module 226, similarly to match resolution module 220, may match the entry feature vector to an infraction feature vector of the set of infraction feature vectors based on the matching scores.

Remediation action module 228 triggers a remediation action responsive to entry monitoring module 226 detecting the entry of a vehicle associated with an infraction. Example remediation actions include issuing an infraction (e.g., parking ticket or other citation), contacting an administrator of the managed facility, contacting an external authority (e.g., law enforcement), deploying an exit or entry blocking device that prevents movement of the vehicle within the managed facility (e.g., metal bars, tire shredder, closing or not opening the gate), displaying a message to a user associated with the vehicle, or otherwise requesting an action from the user (e.g. email, text, or push notification). An example remediation action is shown with respect to FIG. 13C.

In some embodiments, remediation action module 228 trigger different remediation actions for different types of infractions. As such, remediation action module 228 may determine the type of infraction and transmit a remediation command resulting in the remediation action based on the infraction type. For example, for the infraction of entering the managed facility with no profile associated with the vehicle, the remediation action module 228 may trigger an action prompting a user of the vehicle to enter profile details (e.g., contact information, license plate number). In another example, for the infraction of taking up multiple parking spaces, remediation action module 228 may trigger a remediation action that allocates for the use of the multiple parking spaces. For the infraction of damaging a gate, remediation action module 228 may trigger a remediation action of contacting an administrator of the managed facility. In some embodiments, remediation action module 228 may trigger different remediation actions depending on the managed facility. Remediation action module 228 may store remediation action preferences for different managed facilities, for example in managed facility preferences storage 364 of vehicle management server 130. In some embodiments, remediation action module 228 may trigger multiple remediation actions. For example, remediation action module 228 may trigger two remediation actions at once. Additionally or alternatively, remediation action module 228 may trigger a first a remediation action and wait a threshold window of time before cancelling or triggering a second remediation action. For example, remediation action module may issue a message to a user and wait ten minutes before contacting law enforcement. Responsive to the user resolving the issue within the threshold time window, remediation action module 228 may cancel the second remediation action. Responsive to the user not resolving the issue within the threshold time window, remediation action module 228 may trigger the second remediation action.

Remediation action module 228 may remove the vehicle from the infraction database. Remediation action module 228 may remove the vehicle from the infraction database in response to a request from an administrator of a managed facility or in response to the user of the vehicle performing a remediation response corresponding to the remediation action (e.g., creating a profile, addressing a citation, etc.).

FIG. 3 illustrates one embodiment of exemplary modules operated by a vehicle management server. As depicted in FIG. 3, vehicle management server 130 includes vehicle identification module 332, vehicle direction module 334, Model training module 338 336, model training module 338, event retrieval module 340, model database 352, profile database 356, training example database 354, entry data database 358, exit data database 360, infraction database 362, managed facility preferences storage 364, correction data collection module 370, and correction data database 366. The modules and databases depicted in FIG. 3 are merely exemplary, and fewer or more modules and/or databases may be used to achieve the activity that is disclosed herein. Moreover, the modules and databases, though depicted in vehicle management server 130, may be distributed, in whole or in part, to edge device 110, which may perform, in whole or in part, any activity described with respect to vehicle management server 130. Yet further, the modules and databases may be maintained separate from any entity depicted in FIG. 1 (e.g., determination model training module 336 and license plate training module 338 may be housed entirely offline or in a separate entity from vehicle management server 130).

Vehicle identification module 332 identifies a vehicle using the first machine-learning model and/or second machine-learning model described with respect to entry detection module 212. In particular, vehicle identification module 332 accesses the first machine-learning model and/or second machine-leaning model from model database 352, and applies input images and/or any other data to the machine-learning model, receiving parameters of the vehicle therefrom. Vehicle identification module 332 acts in the scenario where images are transmitted to vehicle management server 130 for processing, rather than being processed by edge device 110. Similarly, vehicle direction module 334 determines a direction of a vehicle within images captured at edge device 110 by cameras 112 in the manner described above with respect to entry detection module 212, except by using images and/or other data received at vehicle management server 130 as input, rather than being processed by edge device 110.

Model training module 338 trains the first machine-learning model to predict parameters of vehicles in the manner described above with respect to entry detection module 212. Model training module 338 may additionally train the first machine-learning model to predict direction of a vehicle. Model training module 338 may access training examples from training example database 354 and may store the models at model database 352. Similarly, model training module 338 may train the second machine-learning model using training examples stored at training example database 354 and may store the trained model at model database 352.

In addition, the model training module 338 is configured to improve the performance of the vehicle identification module 332 by identifying and addressing gaps in the training example dataset 354. In some embodiments, the model training module 338 analyzes the distribution of the training example dataset 354 and identifies patterns in misidentified license plate images to detect gaps. When a gap is identified, the model training module 338 applies a diffusion model trained to produce synthetic license plate images that represent the missing data characteristics. This diffusion model is trained using real license plate images to apply forward and reverse diffusion processes, generating realistic, noise-free synthetic images.

In some embodiments, to ensure the diffusion model is sufficiently trained, the model training module 338 uses metrics such as Structural Similarity Index (SSIM), Peak Signal-to-Noise Ratio (PSNR), and Fréchet Inception Distance (FID) to assess the synthetic images' similarity to real images. Once the images meet quality standards, the model training module 338 releases the diffusion model for use.

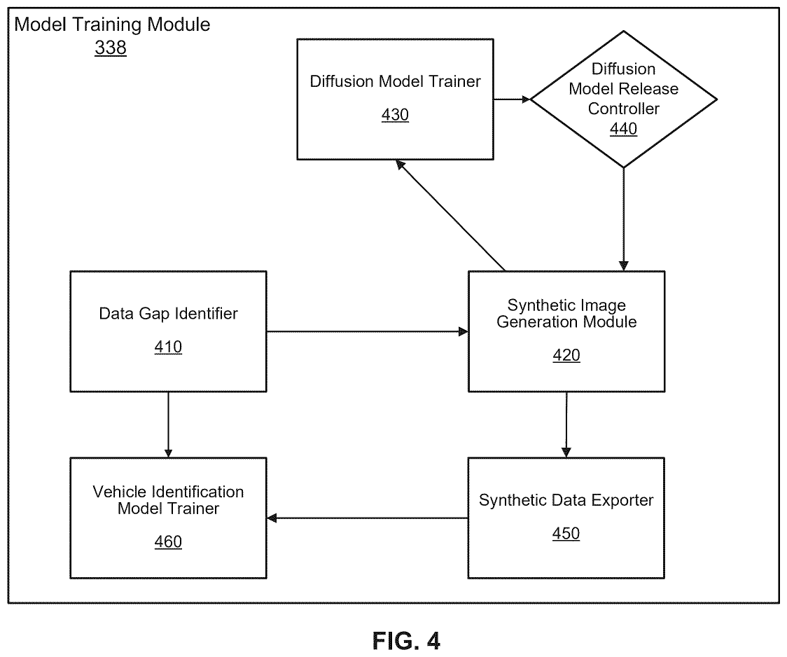

Given the non-deterministic nature of the diffusion model, the model training module 338 may also evaluate and select a subset of the synthetic images for retraining the vehicle identification model based on their quality. In some embodiments, the model training module 338 may use an OCR model and a scoring system to select high-quality synthetic images for incorporation into the training example dataset 354. Additional details about the model training module 338 are further described below with respect to FIGS. 4-12.

Event retrieval module 340 receives instructions from event matching module 218 to retrieve entry data from entry data database 358 that matches detected exit data, and returns at least partially matching data and/or a decision as to whether a match is found to event matching module 218. Event retrieval module 340 optionally stores the exit data to exit data database 360.

Profile database 356 stores profile data for vehicles that are encountered. For example, identifying information and/or license plate information may be used to index profile database 356. As a vehicle enters and exits facilities, profile database 356 may be populated with profiles for each vehicle that store those entry and exit events. Profiles may indicate owners and/or drivers of vehicles and may indicate contact information for those users. Event retrieval module 340 may retrieve contact information when an event is detected and may initiate communications with the user (e.g., welcome to managed facility message, or other information relating to usage of the facility).

The correction data collection module 370 is configured to collect correction data from the match resolution module 220 and the client device 140. As discussed above, some of the hanging events are automatically resolved by the match resolution module 220, and the remaining hanging events are manually resolved by users via the client device 140. When the hanging events are resolved, a hanging entry event and a hanging exit event are matched, and the identifier of the vehicle in one of the events must be corrected to be the same as the other event to form a match. This corrected identifier associated with the images captured during that event can be transformed into a new training example. The correction data collection module 370 collects and stores the correction data in the correction data database 366 and generates new training examples based on the correction data. These new training examples can then be stored with the training example database 354 and used to retrain the vehicle identification model. The retrained vehicle identification model can then be stored in the model database 352 and deployed onto the edge device 110 to detect identifiers of the license plate from incoming traffic.

### Example License Plate Model Training Module

FIG. 4 illustrates an example architecture of a model training module 338 in according to some embodiments. The module training module 338 includes a data gap identifier 410, a synthetic image generation module 420, a diffusion model trainer 430, a diffusion model release controller 440, a synthetic data exporter 450, a vehicle identification model(s) trainer 460.

The data gap identifier 410 is configured to identify gaps in a training dataset. In some embodiments, the data gap identifier 410 analyzes a data distribution and metadata from a training dataset. In some embodiments, the data gap identifier 410 identifies gaps based on misidentified license plates by existing vehicle identification model(s).

The synthetic image generation module 420 may include a diffusion model trained via a diffusion model trainer 430. The synthetic image generation module 420 includes a forward diffusion module that gradually adds noise to input data over a series of time steps, converting the data into random noise, and a reverse diffusion module that gradually denoises the noisy data by learning the reverse transitions of the forward process. This is achieved by training a neural network, such as a U-Net, to predict the noise added at each time step, effectively learning to undo the noise step by step. Once the model is sufficiently trained, the synthetic image generation module 420 can be used to generate new images.

Whether the diffusion model is sufficiently trained is determined based on one or more performance metrics, such as the Structural Similarity Index (SSIM), Peak Signal-to-Noise Ratio (PSNR), Mean Squared Error (MSE), Learned Perceptual Image Patch Similarity (LPIPS), Fréchet Inception Distance (FID), Fréchet CLIP Distance (FCD), among others. These metrics are used to compare pixel-level similarity between the generated image and a reference image (which may be an original, real, or ground-truth image). Upon determining that the generated image and the reference image are sufficiently similar, the diffusion model release controller 440 determines that the synthetic image generation module 420 is ready for production release. The diffusion model is trained to take input data including guidance prompts and license plate image to generate a synthetic license plate image. A guidance prompt includes details about license plates such as “California license plate ABC123 with registration month ‘January’ and year ‘2024’ and slogan ‘The Golden State’”, which guides the generation process. The synthetic image generation module 420 is also conditioned with additional information like masks and component coordinates for fine-tuning generation outputs (e.g., positioning of license plate characters and layout).

The synthetic data exporter 450 is configured to use an OCR model to detect LP characters and annotations from generated images, and use a score generated by a neural network combined with embedding-based cluster to select the most promising prompts and images for output. In some embodiments, the score is a clip score generated by a CLIP-VIT model (contrastive language-image pretraining using vision transformer). The CLIP-VIT model includes a text encoder and an image encoder. The clip score corresponds to a similarity between the image and text embeddings produced by the CLIP-VIT model. The higher the clip score, the more aligned the image is with the text description. The synthetic data exporter 450 selects the synthetic images generated by the synthetic image generation module 420 that have a clip score greater than a predetermined threshold to input into the vehicle identification model trainer 460. The identification model trainer 460 in turn trains one or more vehicle identification models based on the received synthetic images.

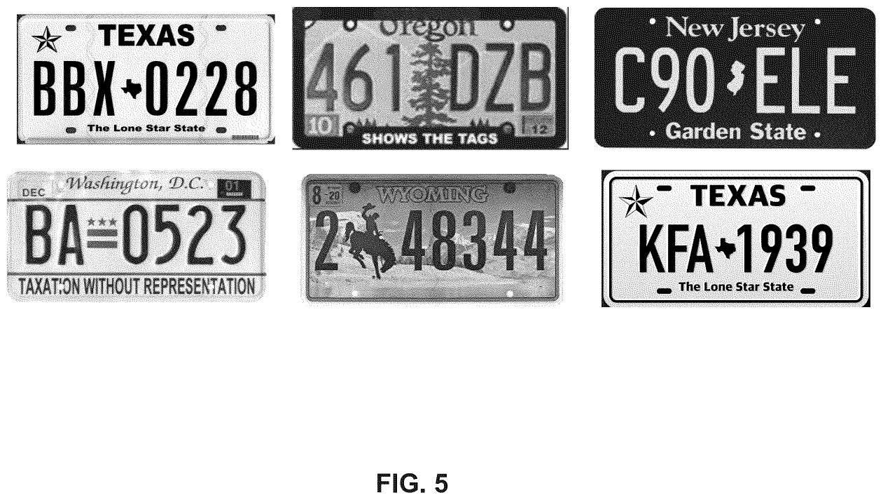

FIG. 5 illustrates example license plate images that represent different layout designs under different lighting in accordance with one or more embodiments. These license plate images may be used to train or retrain a diffusion model, a layout generation model, and/or the license plate identification model.

The top left plate is a Texas plate. The state name “TEXAS” is positioned at the top center of the plate. A star symbol is present to the left of the characters. The license plate characters are centered, with “4CN TN” in bold. The registration month “AUG” is shown in small box at the top right.

The top center, bottom left, and bottom center plates are all New Jersey plates. Each displays the state name, “New Jersey,” at the top, with the tagline “Garden State” at the bottom. The license plate characters are centered, featuring variations in font sizes and styles. A registration sticker labeled “AUG” is positioned in a small box at the top left of each plate. These plates exhibit differences in lighting conditions and character arrangement, adding complexity to their identification.

The top right plate is a Wyoming plate. The state name “WYOMING” is positioned at the bottom center. There is a silhouette of a cowboy on a bucking horse to the left, integrated into the design. The license plate characters, “D 5NC3”, are displayed prominently in the center. The registration sticker “AUG” is in a small box on the top left, with the year shown at the bottom right.

The bottom right plate is a Washington, D.C. plate. The plate includes “Washington, D.C.” at the top, along with a slogan “Celebrate & Discover.” The license plate characters “YPM Q9H” are center on the plate. A small box with “AUG” appears at the top left, with the year shown at the bottom right.

Each layout displays a unique combination of character positioning, state identifiers, registration month/year placement, and decorative or symbolic elements. These variations demonstrate how differing design and layout configurations can lead the license plate identification model to misinterpret an element, mistaking it for something specific to one state when it actually represents something different in another state.

### Example Diffusion Process

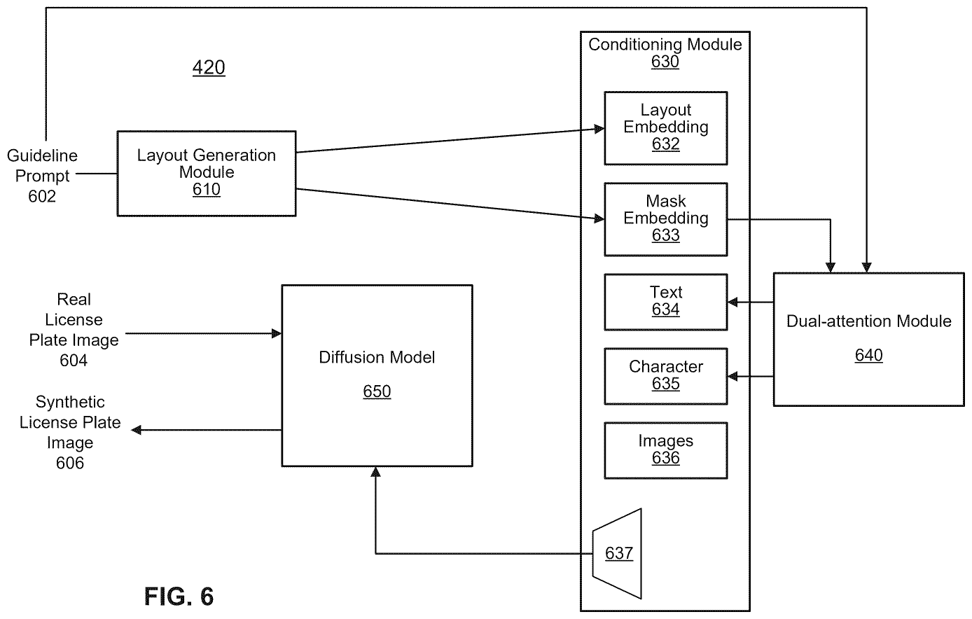

FIG. 6 illustrates an example architecture of the synthetic image generation module 420 in accordance with one or more embodiments. The synthetic image generation module 420 includes a layout generation module 610, a conditioning module 630, a dual attention module 640, a diffusion model 650, an encoder and a decoder. The layout generation module 610 is configured to automatically generate a layout for a license plate based on specified elements from a guidance prompt. The guidance prompt specifies an instruction for generating a synthetic license plate image. In some embodiments, the guidance prompt may include a jurisdiction, a month of registration, a year of registration, a license plate characters, and a slogan, e.g., “California license plate ABC123 with registration month ‘January’ and year ‘2024’ and slogan ‘The Golden State’”.

In some embodiments, the synthetic image generation module 420 is configured to generate the guidance prompt using random values and/or user input. For instance, if a user specifies that a California plate should be generated, the module 420 can create random values for the license plate number, registration month, and year. Additionally, the module 420 may determine a slogan associated with California based on the user's input. Using this combination of user-provided, generated, and selected values for the elements of a California plate, the synthetic image generation module 420 constructs the guidance prompt.

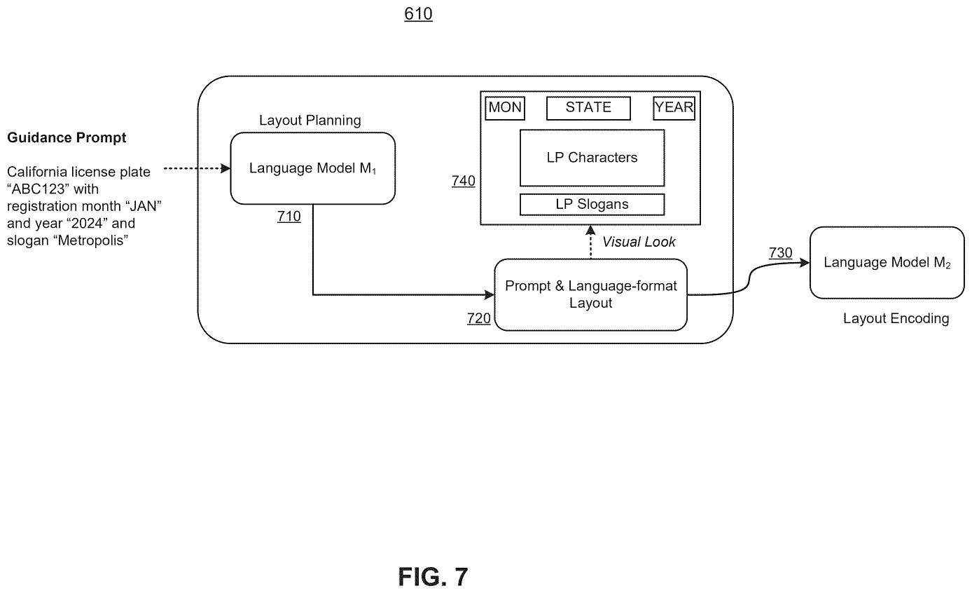

The layout generation module 610 is also configured to encode the generated layout into a set of condition embeddings 637. The set of condition embeddings may include a layout embedding associated with the layout of the license plate and a mask embedding associated with regions that are to be masked and not to be modified by the diffusion model. Additional details about the layout generation model 610 are further described below with respect to FIG. 7.

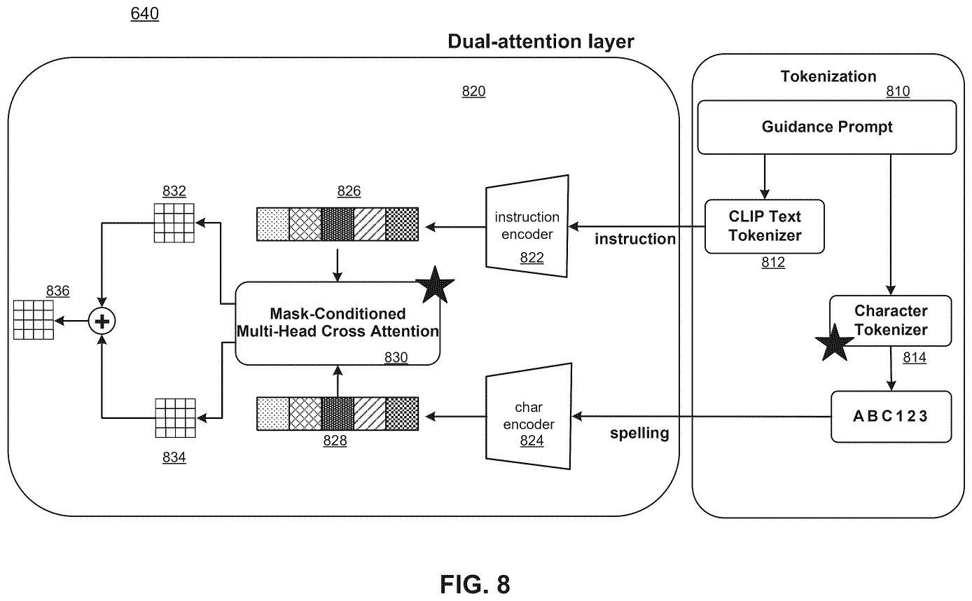

The dual attention module 640 also receives the guidance prompt and applies dual attention mechanisms to focus on specific areas of interest within the guidance prompt to generate tokens based on the mask embedding 633 generated by the layout generation module 610. In particular, the dual attention module 640 includes a text tokenizer configured to tokenize the guidance prompt into a text token, which represent words or sub-words in the guidance prompt. The dual attention module 640 also includes a character tokenizer configured to tokenize the guidance prompt into character token, which represents characters in the guidance prompt. The text token and character token are then encoded into a text embedding 634 and a character embedding 635. Additional details about the dual attention module 640 are further described below with respect to FIG. 8.

The conditioning module 630 receives the layout embedding and the mask embedding from the layout generation module 610 and receives the text embedding and the character embedding generated by the dual attention module 640. Further, the conditioning module 650 also generates or receives an image embedding generated based on the original license plage image 604. The conditioning module 630 integrates these embeddings into a unified condition embedding 637, which is a vector representation of conditions to guide the diffusion model 650 to generate synthetic license plate image 606.

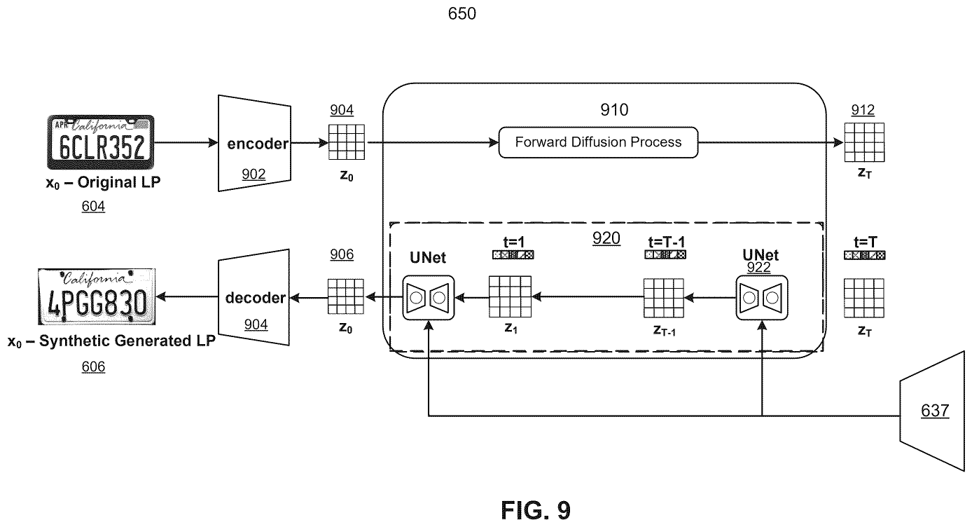

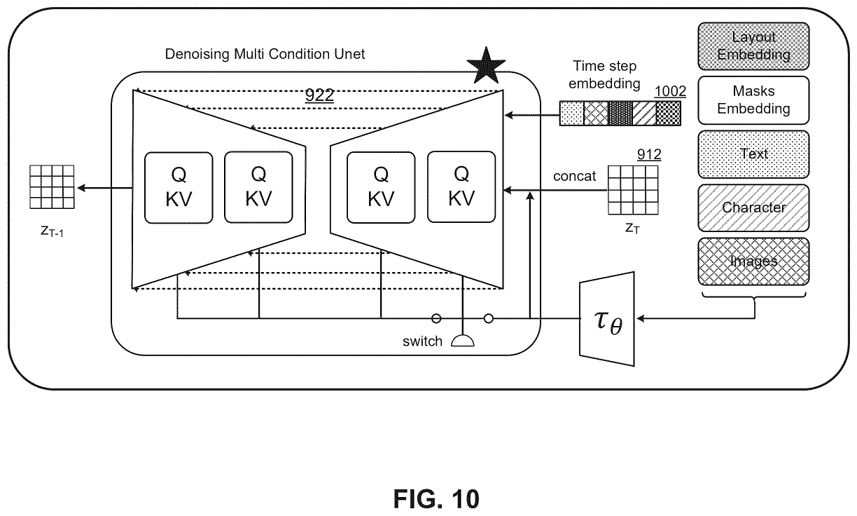

The diffusion model 650 encodes the original license plate image 604 into a latent vector and the applies a two-phase process including forward diffusion and reverse diffusion. During forward diffusion, the model 650 incrementally adds noise to the latent vector corresponding to the initial license plate image 604 over a series of time steps, gradually converting it into a fully noisy image. During reverse diffusion, the model iteratively removes the noise from the latent vector corresponding to the fully noisy image to generate a clean vector corresponding to a clean synthetic image conditioned based on the condition embedding generated by the conditioning module 630. Additional details about the diffusion model 650 are further described below with respect to FIGS. 9-10.

FIG. 7 illustrates an example architecture of the layout generation module 610, in accordance with one or more embodiments. The layout generation module 610 includes a first language model 710, a layout generation model 720, and a second language model 730. The first language model 710 is configured to receive a guidance prompt, such as “California license plate ABC123 with registration month ‘January’ and year ‘2024’ and slogan “The Golden State”. The first language model 710 parses the received prompt to identify the elements in the guidance prompt, and maps the guidance prompt to a particular license plate template. For example, here, the first language model 710 determines that the above example prompt corresponds to a California license plate template 740, and each element in the guidance prompt corresponds to an element of the California license plate template, such as month, state, year, license plate characters, license plate slogans, etc. The first language model 710 maps each element in the guidance prompt to an element in the license plate template, and passes the mapped information to the layout generation model 720.

The layout generation model 720 identifies a layout template based on the received information associated with the guidance prompt. For example, the layout generation model 720 may identify a California license plate template based on “California” included in the guidance prompt. The layout generation model 720 then generates the layout of the license plate. In some embodiments, the layout generation model 720 determines the position and size of each element (e.g., state, month, year, characters, slogans) based on the identified layout template. In some embodiments, the layout generation model outputs a data structure that specifies a two-dimensional position (e.g., x and y coordinates) and size (e.g., width and height) for each element. For example, the data structure may include [STATE] [x1] [y1] [w1] [h1], [MON] [x2] [y2] [w2] [h2], and so on. This data structure indicates that the state element (e.g., California) is positioned at the coordinates x1, y1 with a width of w1 and a height of h1, and the month element (e.g., JAN) is positioned at the coordinates x2, y2 with a width of w2 and a height of h2, and so on.

In some embodiments, the layout generation model 720 is a machine-learning model trained over real license plate images. In some embodiments, the layout generation model 720 is trained over a set of annotated real license plate images. For example, each image is labeled with coordinates for specific license plate elements (e.g., state, month, year, characters, slogan, etc.) to provide a mapping of where each element should appear on a plate. The model 720 uses these labels to learn typical layout configurations. By observing labeled images, the model 720 understands how each layout should vary according to factors like state or element type. The model 720 also learns to generalize different layout types, accounting for potential variations within a state or across different jurisdictions. In some embodiments, the model 720 is trained to received textual data associated with different elements of plate, and associates the received elements with expected layout patterns.

The second language model 730 receives the text-based layout information from the layout generation model 720 and converts this information into a vectorized format (also referred to as “embeddings”). The embeddings encode the layout in a machine-readable format, enabling the downstream model to interpret. In some embodiments, the second language model 730 converts the layout information into a layout embedding 632 and a mask embedding 633. The layout embedding 632 is a vector representation that encodes the spatial arrangement of elements on the license plate. For example, the layout embedding 632 may indicate the position and size of each element (e.g., state, month, year, license plate characters, and slogans) in a machine-readable format. The mask embedding 633 is a vector representation that specifies areas of the license plate image designated as “masked” for the downstream task. These masked areas are intended to remain unaltered by the diffusion model 650, ensuring that certain regions of the image are preserved as they are during the synthetic image generation process. The layout embedding 632 and mask embedding 633 are output to the conditioning module 630.

Furthermore, the guidance prompt 602 is also input to the dual-attention module 640. FIG. 8 illustrates an example architecture of a dual-attention module 640, in accordance with one or more embodiments. The dual attention layer includes a tokenization module 810 and a dual attention processing module 820. The tokenization module 810 includes a text tokenizer 812 and a character tokenizer 814. The text tokenizer 812 is configured to convert the input text (the guidance prompt 602) into text tokens. Each text token is a numeric representation of a word or a sub-word. For example, a guidance prompt like “California license plate with ABC 123” may be tokenized into a sequence of numbers, each representing a word in the guidance prompt. The character tokenizer 814 is configured to convert the license plate character in the guidance prompt 602 into character tokens. Each character token is a numerical representation of a character. For example, a license plate characters like “ABC 123” is tokenized into separate tokens, each representing “A”, “B”, “C”, “1”, “2”, and “3”.

The text tokens (also referred to as instruction tokens) and character tokens (also referred to as spelling tokens) are input to the dual-attention processing module 820. The dual-attention processing module 820 includes an instruction encoder 822 configured to encode the received instruction tokens into instruction embeddings 826, and a character encoder 824 configured to encode the received character tokens into character embeddings 828. The dual-attention processing module 820 also includes a mask-conditioned multi-head cross attention module 830 configured to receive the instruction embedding 826 and character embedding 828 and selectively attend to specific parts of an instruction embedding 826 or character embedding 828 based on conditions associated with mask embeddings 633. For example, the mask-conditioned multi-head cross attention module 830 may be configured to focus only on text or characters in regions where characters need to be generated or modified. The result of applying the mask-conditioned multi-head cross-attention by module 830 is the updated instruction embedding 832 and updated character embedding 834. The updated instruction embedding 832 and updated character embedding 834 are then combined into a unified embedding 836 and output to the conditioning module 630.

The conditioning module 630 receives the layout embedding 632 and mask embedding 633 from the layout generation module 610, and receives text embedding 634 and character embedding 635 from the dual-attention module 640. The condition module 630 also generates an image embedding 636 based on the received real license plate image 604. The condition module 630 uses the layout embedding 632, mask embedding 633, text embedding 634, character embedding 635, and license plate image embedding 636 to generate a unified condition embedding 637 to guide the synthetic image generation process by the diffusion model 650. For examples, the layout embedding 632 restricts where each element should be positioned on the synthetic image. The mask embedding 633 restricts areas of the license plate that should remain unaffected. The text embedding 634 provides a semantic guidance to influence generation process. The character embedding 635 provides the letters that are to be appeared in a correct order in the synthetic image as the license plate numbers.

The diffusion model 650 is configured to receive a real license plate image 604 as input to generate a synthetic license plate image 606 based on the condition embedding received from the conditioning module 630.

FIG. 9 illustrates an example architecture of a diffusion model 650, in accordance with one or more embodiments. The diffusion model 650 includes an encoder 902, a decoder 908, a forward diffusion module 910 and a reverse diffusion module 920. The encoder 902 is configured to receive an original license plate image 604 (denoted as x0) and encode the image 604 into a latent vector 904 (denoted as z0). The latent vector 904 represents a compressed form of the original image, capturing information like structure, colors, and characters, but in a lower-dimensional space.

The latent vector 904 is input into the forward diffusion module 910. The forward diffusion module 910 is configured to add noise incrementally to z0. For example, in a first time step, the forward diffusion module 910 adds some noise to z0 to generate z1; in a second time step, the forward diffusion module 920 adds some noise to z1 to generate z2, and so on and so forth. As illustrated in FIG. 9, there are total T time steps. Thus, the resulting vector after the forward diffusion module 910 is a vector 912 (denoted as zT).

The vector 912 zT is then input into the reverse diffusion module 920. The reverse diffusion module 920 includes a sequence of UNet 922 (e.g., a total of T UNet). Each UNet 922 is configured to transform the noisy vector 912 back into a denoised vector that represents a synthetic license plate image that closely matches the original image 604. At the same time, the denoise process is also guided by the condition embedding 637 generated by the conditioning module 630.

FIG. 10 illustrates an example architecture of a UNet 922, in one or more embodiments. The U-Net 922 is configured to receive time step embedding 1002 and noisy vector zT 912 to denoise the noisy vector zT to output a less noisy vector zT-1. The time step embedding 1002 encodes information about the specific time step t within the reverse diffusion process. It serves a guide for the UNet 922 about the current stage of denoising, allowing the UNet 922 to apply a correct amount and a type of refinement at the time step. Further, the UNet 922 is conditioned with the condition embedding associated with layout, mask, text, character, and image embeddings.

The UNet 922 includes multiple query (Q), key (K), and value (V) blocks. Each of the Q, K, V blocks applies a vector that enables the UNet to apply attention to a part of the image or conditioning inputs at the current stage. For each query (Q) vector, the UNet 922 determines a similarity score with key (K) vector. This score represents an “attention” level that the UNet should pay to each corresponding value (V) vector. The attention scores are then used to weight the V vector to determine how much each value should contribute to the final output. by focusing on certain values more than others, the model can enhance relevant features in the image or incorporate specific conditioning information (e.g., layout, mask, character, etc.). The output of the UNet 922 (e.g., zT-1) is then input to a next UNet, which includes the same architecture as the UNet 922. The next UNet is configured to output a less noisy vector zT-2. This process repeat T times until the last UNet, which output a completely denoised vector 906 (denoted z0).

Referring back to FIG. 9, the completely denoised vector 906 is then decoded by the decoder 908 into a synthetic license plate image 606. The synthetic license plate image 606 may be evaluated by the synthetic data exporter 450 to determine its quality. The synthetic data exporter 450 determines one or more metrics based on analyzing the generated synthetic image 606 with the input real license plate image 604 and the guidance prompt 602. For example, in some embodiments, the synthetic data exporter 450 may be configured to compare structural information in the synthetic image 606 and real image 604 to determine a structural similarity index (SSIM). A higher SSIM indicates a close resemblance. Additionally, in some embodiments, the synthetic data exporter 450 may apply OCR to the synthetic image 606 to extract textual information, and compare the textual information extracted from the synthetic image 606 with the textual information in the guidance prompt to determine a similarity. The synthetic data exporter 450 may determine whether the synthetic image 606 is sufficiently good to be used as a training example based on the structural similarity and textual similarity. For example, a first threshold may be set for SSIM, and a second threshold may be set for textual similarity. Both SSIM and textual similarity need to be above their respective threshold to allow the synthetic image 606 to be included as a training sample.

### Example Methods for Generating Synthetic License Plate Images

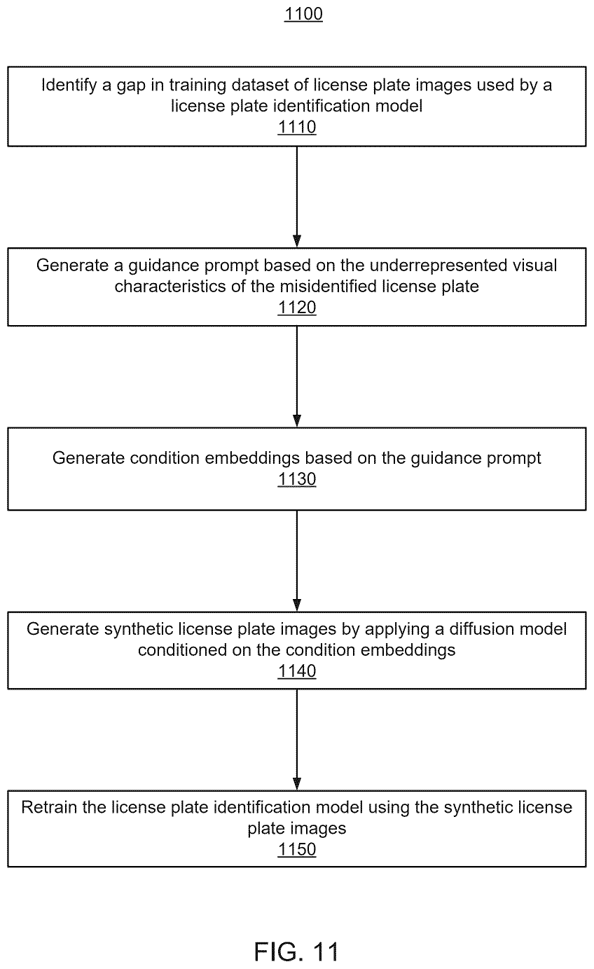

FIG. 11 depict one embodiment of an exemplary method 1100 for improving vehicle identification accuracy in a vehicle management system in accordance with one or more embodiments. Alternative embodiments may include more, fewer, or different steps from those illustrated in FIG. 11, and the steps may be performed in a different order from that illustrated in FIG. 11. Method 1100 may be executed by one or more processors of a system, which may include an edge device 110, a vehicle management server 130, and/or a client device 140. The one or more processors may include processor of edge device 110 and/or of vehicle management server 130 executing instructions that cause one or more modules to perform their respective operations.

The system identifies 1110 a gap in training dataset of license plate images used by a license plate identification model. The gap corresponds to underrepresented visual characteristics in a misidentified license plate. The underrepresented visual characteristics may include, but are not limited to, distinctive character fonts or sizes, varying character spacing or alignment, specific symbols or graphics, background colors or patterns, and uncommon slogans or taglines unique to a particular jurisdiction's license plates. In some embodiments, underrepresented characteristics may also include variations in lighting, environmental conditions, as well as differences in angle and perspective.

In some embodiments, identifying the gap in the training dataset includes analyzing data distribution of the training dataset to identify a gaps in the data distribution of the training dataset. In some embodiments, identifying the gap in the training dataset includes identifying recurring misidentifications by the vehicle identification model. For example, the system may examine specific attributes such as character font, size, spacing, and positioning of license plates, as well as unique symbols, background colors, and patterns for each jurisdiction's license plates. The system can also track recurring misidentifications by the vehicle identification model to identify specific visual characteristics that the model frequently misidentify. The system can then identify the underrepresented attributes in the dataset, prompting targeted synthetic data generation to fill these gaps.

The system generates 1120 a guidance prompt based on the underrepresented visual characteristics of the misidentified license plate. For example, a guidance prompt may be “California license plate “ABC123” with registration month “JAN” and year “2024” and slogan “The Golden State”. In some embodiments, the system is configured to generate the guidance prompt using random values and/or user input. For instance, if a user specifies that a California plate should be generated, the system can create random values for the license plate number, registration month, and year. Additionally, the system may determine a slogan associated with California based on the user's input. Using this combination of user-provided, generated, and selected values for the elements of a California plate, the system can then generate the guidance prompt.

In some embodiments, the underrepresented visual characteristics may include, but are not limited to, distinctive character fonts or sizes, varying character spacing or alignment, specific symbols or graphics, background colors or patterns, and uncommon slogans or taglines unique to a particular jurisdiction's license plates.

The system generates 1130 condition embeddings based on the guidance prompt. In some embodiments, the condition embeddings may include (but are not limited to) a layout embedding, a mask embedding, a text embedding, a character embedding generated based on the guidance prompt. In some embodiments, the condition embeddings further include an image embedding generated based on an input real license plate image.

The system generates 1140 synthetic license plate images by applying a diffusion model conditioned on the condition embeddings. The diffusion model is trained to receive a real license plate image as input, encode the real license plate image into a vector, apply forward diffusion to the vector to incrementally add noise, generating a noisy vector associated with the real license plate image with added noise, apply reverse diffusion to the noisy vector to produce a denoised vector representing a synthetic license plate image, conditioned on the condition embeddings, and decode the denoised vector to create the synthetic license plate image.

In some embodiments, the diffusion model is trained by accessing a training dataset including real license plate images annotated with license plate element locations, sizes, and associated metadata. The metadata includes a jurisdiction. For each of the real license plate images, the system encodes the real license plate image into an initial vector representation, and applies a forward diffusion process to the initial vector to add noise to the initial vector to generate a noisy vector corresponding to the real license plate image with noise added. The system trains a reverse diffusion block to denoise the noisy vector to generate a denoise vector approximate the initial vector, conditioned on condition embeddings associated with positions and sizes of a plurality of license plate elements. The system determines a reconstruction error based on a difference between the denoised vector and the initial vector and adjusts weights of the reverse diffusion block to reduce the reconstruction error.

The system retrains 1150 the license plate identification model using the synthetic license plate images. Given the non-deterministic nature of the diffusion model, the same guidance prompt can produce different images with each generation. Therefore, in some embodiments, the system may generate multiple synthetic images from a single guidance prompt. Additionally, as previously described, the system can produce as many guidance prompts as needed to generate a wide array of synthetic images.

Some of these images may meet the quality standards required for training data, while others may not be suitable. In some embodiments, the system applies a scoring metric to each of the plurality of synthetic license plate images to determine a compliance score between the synthetic image and the guidance prompt. The compliance score indicates whether the synthetic is compliance with the guidance prompt. The system selects a subset of the generated synthetic license plate images based on the compliance scores, and retrains or fine-tunes the vehicle identification model using the selected subset of synthetic license plate images.

In some embodiments, the system applies an optical character recognition (OCR) to extract alphanumeric characters from the synthetic images, and compares the extracted characters with expected characters as indicated in the guidance prompt to determine a similarity. In some embodiments, the scoring metric further comprises at least one of following performance metrics: structural similarity index (SSIM), peak signal-to-noise ratio (PSNR), mean squared error (MSE), learned perceptual image patch similarity (LPIPS), Fréchet inception distance (FID), and Fréchet contrastive language-image pretraining (CLIP) distance (FCD). In some embodiments, the system may set one or more thresholds for one or more scoring metrics. Responsive to determining that the one or more metrics scores are greater than their respective thresholds, the system determines that the synthetic image meets the quality standards required for training data.

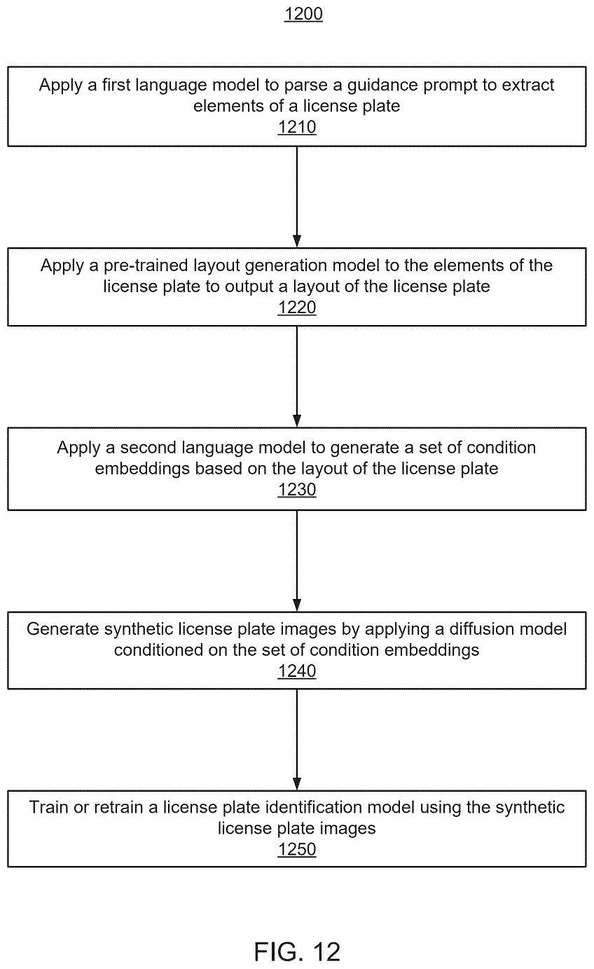

FIG. 12 depict one embodiment of an exemplary method 1200 for improving vehicle identification accuracy in a vehicle management system in accordance with one or more embodiments. Alternative embodiments may include more, fewer, or different steps from those illustrated in FIG. 12, and the steps may be performed in a different order from that illustrated in FIG. 12. Method 1200 may be executed by one or more processors of a system, which may include an edge device 110, a vehicle management server 130, and/or a client device 140. The one or more processors may include processor of edge device 110 and/or of vehicle management server 130 executing instructions that cause one or more modules to perform their respective operations.

The system applies 1210 a first language model to parse a guidance prompt to extract elements of a license plate. The guidance prompt specifies an instruction for generating a synthetic license plate image. In some embodiments, the guidance prompt includes one or more of a jurisdiction associated with the license plate, a month of registration, a year of registration, and a slogan. In some embodiments, the system generates a random value for each element of the license plate, and generates the guidance prompt based on the generated random values.

The system applies 1220 a pre-trained layout generation model to the elements of the license plate to output a layout the license plate. The pre-trained layout generation model is trained using real license plate images labeled with bounding boxes for each of the elements. In some embodiments, the pre-trained layout generation model is configured to identify a license plate template based on the guidance prompt. For example, the license plate template may be identified based on the jurisdiction specified in the guidance prompt.

In some embodiments, the identified license plate template includes one or more elements, such as the jurisdiction associated with the license plate, registration month, registration year, and a slogan. The guidance prompt includes corresponding elements that match the elements of the identified license plate template. Each element on the license plate has an associated two-dimensional coordinate indicating its position according to the template. Determining the position of an element involves generating a two-dimensional coordinate based on the template's designated position for that element. In some embodiments, the license plate also specifies a width and height for each element. Generating the size of an element on the license plate includes setting a width and height that aligns with the dimensions specified in the license plate template for that element.

The system applies 1230 a second language model to generate a set of condition embeddings based on the layout of the license plate. In some embodiments, the set of condition embeddings includes a layout embedding corresponding to the layout of the license, and a mask embedding corresponding to regions of the license plate that is to be masked and not to be modified by the diffusion model. In some embodiments, the system further applies dual attention to the guidance prompt based on the mask embedding to generate a text embedding corresponding to words or sub-words in the guidance prompt, and a character embedding corresponding to characters in the guidance prompt.

The system generates 1240 synthetic license plate images by applying a generative model conditioned on the set of condition embeddings. In some embodiments, the generative model may be trained via various algorithms, such as (but not limited to) generative adversarial networks (GANs), variational autoencoders (VAEs), diffusion models, autoregressive models, flow-based models, transformer-based models, and/or energy-based models.

In some embodiments, the generative model is a diffusion model. The diffusion model is trained to receive a real license plate image as input, encode the real license plate image into a vector, apply forward diffusion to the vector to incrementally add noise, generating a noisy vector associated with the real license plate image with added noise, apply reverse diffusion to the noisy vector to produce a denoised vector representing a synthetic plate image, conditioned on the condition embeddings, and decode the noise vector to crate the synthetic license plate image.

The system trains or retrains 1250 a license plate identification model using the synthetic license plate images. Similar to the method 1100, the system may generate as many synthetic license plate images as necessary, and may select a subset as training dataset to retrain the license plate identification model.

### Example Managed Facility

FIGS. 13A-C depict embodiments of an exemplary managed facility and moveable gate. As depicted in FIG. 13A, a managed facility 1300 includes a set of parking spaces 1302 within which vehicles 1305 (e.g., cars) may park. Managed facility 1300 includes sensors, such as parking sensors 1315 and cameras 112. Parking sensors 1315 may be located within parking spaces 1302 to detect when vehicles 1305 are present. As depicted on the left-hand side of managed facility 1300, managed facility 1300 includes gates 114. The bottom gate 114 allows vehicles 1305 to enter managed facility 1300 from street 1320 through an entry lane 1340 and the top gate 114 allows vehicles 1305 to exit managed facility 1300 through an exit lane 1335.

Managed facility 1300 may include a pedestrian door 1310, allowing pedestrians to enter from, for example, a sidewalk 1330. The pedestrian door may be locked and RFID enabled such that users may enter through the pedestrian door responsive to edge device 110 receiving, from the user, a set of user credentials. Example user credentials may include user personal information, contact information, account information, and vehicle information (e.g., make, model, color, license plate).

FIG. 13A also depicts an infracting vehicle 1306. Edge device 110 may, through infraction detection module 222, determine that vehicle 1306 is an infracting vehicle due to the way vehicle 1306 is parked, where the vehicle is talking up two parking spots 1302 instead of one parking spot 1302. Responsive to detecting the infraction, edge device 110 may trigger a remediation action that allocates for the use of the multiple parking spaces. Responsive to detecting some infractions, edge device 110 may trigger remediation actions that deploy an exit blocking device (e.g., gate 114) that prevents movement of vehicle 1305 (or 1306) out from managed facility 1300.

FIGS. 13B and 13C depict embodiments of managed facility 1300 in which a two-gate system is implemented in entry lane 1340. The two-gate system includes a first gate 113 with cameras 112 pointed towards it and a second gate 115. Between the first gate 113 and the second gate 115 is a secondary zone 1345. The secondary zone 1345 includes access to the exit lane 1335 (e.g., via crossing the dashed line). FIG. 13B shows operation of the two-gate system responsive to a non-infracting vehicle (e.g., vehicle 1305) attempting to enter the managed facility. In FIG. 13B, responsive to detecting vehicle 1305 at the first gate 113, edge device 110 may open the first gate 113, allowing vehicle 1305 to pass into a secondary zone 1345. While in the secondary zone 1345, cameras 112 may take images of vehicle 1305. Responsive to determining (e.g., through entry monitoring module 226) that vehicle 1305 is not an infracting vehicle, edge device 110 may open the second gate 115, allowing vehicle 1305 to enter managed facility 1300. FIG. 13C shows operation of the two-gate system responsive to an infracting vehicle (e.g., vehicle 1306) attempting to enter the managed facility. In FIG. 13C, responsive to detecting infracting vehicle 1306 at the first gate 113, edge device 110 may open the first gate 113, allowing infracting vehicle 1306 to pass into a secondary zone 1345. While in the secondary zone 1345, cameras 112 may take images of infracting vehicle 1306. Responsive to determining (e.g., through entry monitoring module 226) that vehicle 1306 is an infracting vehicle, instead of opening the second gate 115 as edge device 110 did for vehicle 1305, edge device 110 may trigger a remediation action. For example, as a remediation action, edge device 110 may provide, for display at the second gate 115, a message to a user of infracting vehicle 1306 asking the user to route infracting vehicle 1306 into exit lane 1335.

The aforementioned managed facility could be a parking facility that tags both entry and exit events for vehicles. However, different types of managed facilities might record a single tagged event or multiple tagged events per vehicle. For instance, a carwash facility might only tag a vehicle's entry into the wash area. Conversely, a drive-through restaurant could tag multiple events: one when a driver of the vehicle stops at a location for placing an order and another when the ordered items are handed over to the vehicle, completing the transaction. Additionally, an automated toll might tag just an entry or both an entry and exit event. In facilities that track multiple tagged events, vehicle misidentifications might be identified through unresolved (“hanging”) events. In contrast, facilities that record a single tagged event might detect misidentifications by comparing features between captured images of vehicles and registered vehicles within the system. Responsive to determining a misidentification of a vehicle, corrections can be made either manually or automatically, in a manner similar to that described above. For single tagged event scenarios, the correction data may be obtained without reference to another event. This correction data can also be used to generate additional training examples for retraining the machine-learning model for vehicle identification, continuously enhancing the accuracy of the machine-learning model through human-in-the-loop driven or automated retraining.

### Example Computer System

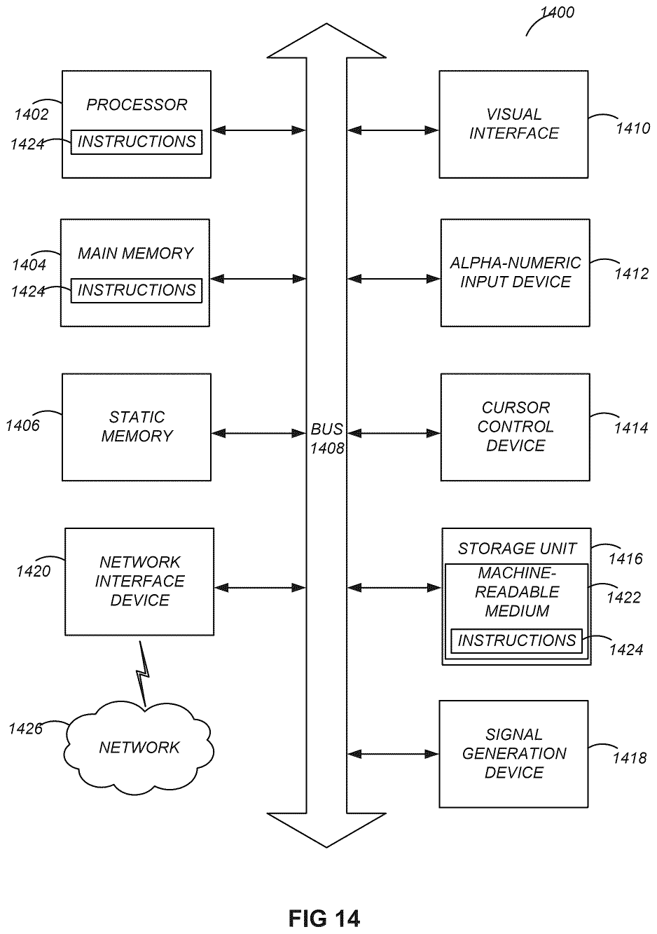

FIG. 14 is a block diagram illustrating components of an example machine able to read instructions from a machine-readable medium and execute them in a processor (or controller). FIG. (FIG. 14 is a block diagram illustrating components of an example machine able to read instructions from a machine-readable medium and execute them in a processor (or controller). Specifically, FIG. 14 shows a diagrammatic representation of a machine in the example form of a computer system 1400 within which program code (e.g., software) for causing the machine to perform any one or more of the methodologies discussed herein may be executed. The program code may be comprised of instructions 1424 executable by one or more processors 1402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 1424 (sequential or otherwise) that specify actions to be taken by that machine. Further, while only a single machine is illustrated, the term “machine” shall also be taken to include any collection of machines that individually or jointly execute instructions 1424 to perform any one or more of the methodologies discussed herein.

The example computer system 1400 includes one or more processors 1402 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 1404, and a static memory 1406, which are configured to communicate with each other via a bus 1408. The computer system 1400 may further include visual display interface 1410. The visual interface may include a software driver that enables (or provide) user interfaces to render on a screen either directly or indirectly. The visual interface 1410 may interface with a touch enabled screen. The computer system 1400 may also include input devices 1412 (e.g., a keyboard a mouse), a cursor control device 1414, a storage unit 1416, a signal generation device 1418 (e.g., a microphone and/or speaker), and a network interface device 1420, which also are configured to communicate via the bus 1408.

The storage unit 1416 includes a machine-readable medium 1422 (e.g., magnetic disk or solid-state memory) on which is stored instructions 1424 (e.g., software) embodying any one or more of the methodologies or functions described herein. The instructions 1424 (e.g., software) may also reside, completely or at least partially, within the main memory 1404 or within the processor 1402 (e.g., within a processor's cache memory) during execution.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for seamless entry and exit to a managed facility blocked by a moveable gate through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for improving vehicle identification accuracy in a vehicle management system, comprising:
identifying a gap in a training dataset of license plate images used by a license plate identification model, wherein the gap corresponds to underrepresented visual characteristics in a misidentified license plate;
generating a guidance prompt based on the underrepresented visual characteristics of the misidentified license plate;
generating condition embeddings based on the guidance prompt;
generating a synthetic license plate image by applying a diffusion model conditioned on the condition embeddings, wherein the diffusion model is trained to:
receive a real license plate image as input;
encode the real license plate image into a vector;
apply forward diffusion to the vector to incrementally add noise, generating a noisy vector associated with the real license plate image with added noise;
apply reverse diffusion to the noisy vector to produce a denoised vector representing a synthetic license plate image, conditioned on the condition embeddings; and
decode the denoised vector to create the synthetic license plate image; and
retraining the license plate identification model using the synthetic license plate image.

2. The method of claim 1, wherein the underrepresented visual characteristics of the misidentified license plate includes one or more of a character font, character size, character spacing, character positioning, a symbol, a background color, a background graphic, and a slogan, specific to a jurisdiction's license plate.

3. The method of claim 1, wherein identifying the gap in the training dataset comprises analyzing data distribution of the training dataset to identify a gap in the data distribution of the training dataset.

4. The method of claim 1, wherein identifying the gap in the training dataset comprises identifying recurring misidentifications by the vehicle identification model.

5. The method of claim 1, wherein applying the forward diffusion to the vector includes iteratively adding noise to a noisy vector generated over a plurality of time steps, and applying the reverse diffusion includes iteratively removing noise from the noisy vector over a plurality of time steps.

6. The method of claim 1, further comprising:
generating a plurality of synthetic license plate images;
applying a scoring metric to each of the plurality of synthetic license plate images to determine a compliance score between the synthetic image and the guidance prompt, the compliance score indicating whether the synthetic is compliance with the guidance prompt;
selecting a subset of the generated synthetic license plate images based on the compliance scores;
retraining or fine-tuning the vehicle identification model using the selected subset of synthetic license plate images.

7. The method of claim 6, wherein applying the scoring metric:
applying optical character recognition (OCR) to extract alphanumeric characters from the synthetic images;
comparing the extracted characters with expected characters as indicated in the guidance prompt to determine a similarity.

8. The method of claim 6, wherein the scoring metric further comprises at least one of following performance metrics: structural similarity index (SSIM), peak signal-to-noise ratio (PSNR), mean squared error (MSE), learned perceptual image patch similarity (LPIPS), Fréchet inception distance (FID), and Fréchet contrastive language-image pretraining (CLIP) distance (FCD).

9. The method of claim 1, wherein the condition embeddings includes a layout embedding, a mask embedding, a text embedding, a character embedding generated based on the guidance prompt.

10. The method of claim 9, wherein the condition embeddings further include an image embedding generated based on existing real license plate images.

11. The method of claim 9, wherein the diffusion model is trained by:
accessing a training dataset comprising real license plate images annotated with license plate element locations, sizes, and associated metadata, the metadata including a jurisdiction;
for each of the real license plate images,
encoding the real license plate image into an initial vector representation;
applying a forward diffusion process to the initial vector to add noise to the initial vector to generate a noisy vector corresponding to the real license plate image with noise added;
training a reverse diffusion block to denoise the noisy vector to generate a denoise vector approximate the initial vector, conditioned on condition embeddings associated with positions and sizes of a plurality of license plate elements;
determining a reconstruction error based on a difference between the denoised vector and the initial vector; and
adjusting weights of the reverse diffusion block to reduce the reconstruction error.

12. A non-transitory computer-readable medium comprising memory with instructions encoded thereon, the instructions comprising instructions to cause one or more processors to perform steps comprising:
identifying a gap in a training dataset of license plate images used by a license plate identification model, wherein the gap corresponds to underrepresented visual characteristics in a misidentified license plate;
generating a guidance prompt based on the underrepresented visual characteristics of the misidentified license plate;
generating condition embeddings based on the guidance prompt;
generating a synthetic license plate image by applying a diffusion model conditioned on the condition embeddings, wherein the diffusion model is trained to:
receive a real license plate image as input;
encode the real license plate image into a vector;
apply forward diffusion to the vector to incrementally add noise, generating a noisy vector associated with the real license plate image with added noise;
apply reverse diffusion to the noisy vector to produce a denoised vector representing a synthetic license plate image, conditioned on the condition embeddings; and
decode the denoised vector to create the synthetic license plate image; and
retraining the license plate identification model using the synthetic license plate image.

13. The non-transitory computer-readable medium of claim 12, wherein the underrepresented visual characteristics of the misidentified license plate includes one or more of a character font, character size, character spacing, character positioning, a symbol, a background color, a background graphic, and a slogan, specific to a jurisdiction's license plate.

14. The non-transitory computer-readable medium of claim 12, wherein identifying the gap in the training dataset comprises analyzing data distribution of the training dataset to identify a gap in the data distribution of the training dataset.

15. The non-transitory computer-readable medium of claim 12, wherein identifying the gap in the training dataset comprises identifying recurring misidentifications by the license plate identification model.

16. The non-transitory computer-readable medium of claim 12, wherein applying the forward diffusion to the vector includes iteratively adding noise to a noisy vector generated over a plurality of time steps, and applying the reverse diffusion includes iteratively removing noise from the noisy vector over a plurality of time steps.

17. The non-transitory computer-readable medium of claim 12, the steps further comprising:
generating a plurality of synthetic license plate images;
applying a scoring metric to each of the plurality of synthetic license plate images to determine a compliance score between the synthetic image and the guidance prompt, the compliance score indicating whether the synthetic is compliance with the guidance prompt;
selecting a subset of the generated synthetic license plate images based on the compliance scores;
retraining or fine-tuning the license plate identification model using the selected subset of synthetic license plate images.

18. The non-transitory computer-readable medium of claim 17, wherein applying the scoring metric:
applying optical character recognition (OCR) to extract alphanumeric characters from the synthetic images;
comparing the extracted characters with expected characters as indicated in the guidance prompt to determine a similarity.

19. The non-transitory computer-readable medium of claim 18, wherein the diffusion model is trained by:
accessing a training dataset comprising real license plate images annotated with license plate element locations, sizes, and associated metadata, the metadata including a jurisdiction;
for each of the real license plate images,
encoding the real license plate image into an initial vector representation;
applying a forward diffusion process to the initial vector to add noise to the initial vector to generate a noisy vector corresponding to the real license plate image with noise added;
training a reverse diffusion block to denoise the noisy vector to generate a denoise vector approximate the initial vector, conditioned on condition embeddings associated with positions and sizes of a plurality of license plate elements;
determining a reconstruction error based on a difference between the denoised vector and the initial vector; and
adjusting weights of the reverse diffusion block to reduce the reconstruction error.

20. A system comprising:
memory with instructions encoded thereon; and
one or more processors that, when executing the instructions, are caused to perform operations comprising:
identifying a gap in a training dataset of license plate images used by a license plate identification model, wherein the gap corresponds to underrepresented visual characteristics in a misidentified license plate;
generating a guidance prompt based on the underrepresented visual characteristics of the misidentified license plate;
generating condition embeddings based on the guidance prompt;
generating a synthetic license plate image by applying a diffusion model conditioned on the condition embeddings, wherein the diffusion model is trained to:
receive a real license plate image as input;
encode the real license plate image into a vector;
apply forward diffusion to the vector to incrementally add noise, generating a noisy vector associated with the real license plate image with added noise;
apply reverse diffusion to the noisy vector to produce a denoised vector representing a synthetic license plate image, conditioned on the condition embeddings; and
decode the denoised vector to create the synthetic license plate image; and
retraining the license plate identification model using the synthetic license plate image.
